(19) United States
(12) Patent Application Publication
(10) Pub. No.: US 2014/0320364 A1
(43) Pub. Date: Oct. 30, 2014

(54) SUBSTRATE INTEGRATED WAVEGUIDE HORN ANTENNA

(71) Applicants: Huanhuan Gu, Waterloo (CA); Houssam Kanj, Waterloo (CA); Christopher DeVries, St. Thomas (CA); James Warden, Fort Worth, TX (US)

(72) Inventors: Huanhuan Gu, Waterloo (CA); Houssam Kanj, Waterloo (CA); Christopher DeVries, St. Thomas (CA); James Warden, Fort Worth, TX (US)

(73) Assignee: RESEARCH IN MOTION LIMITED, Waterloo (CA)

(21) Appl. No.: 13/871,054

(22) Filed: Apr. 26, 2013

(51) Int. Cl. H01Q 13/02

(52) U.S. Cl. CPC H01Q 13/02; H01Q 13/0283
USPC 343/786; 29/600

(57) ABSTRACT

Embodiments are directed to a substrate integrated waveguide (SIW) antenna structure comprising: a first layer configured to route a signal, at least a second layer configured for antenna use coupled to the first layer, and a SIW antenna flared in the E-plane. Embodiments are directed to a method comprising: fabricating a first layer configured to route a signal, fabricating at least a second layer configured for antenna use, coupling the first layer and the at least a second layer, and flaring a substrate integrated waveguide (SIW) antenna in the E-plane.

### BACKGROUND

Spectrum around 60 GHz has attracted interest in connection with communication systems. For example, 60 GHz communication may facilitate a large communication bandwidth and higher data rates relative to lower frequencies of operation (e.g., WiFi). Also, the shorter wavelength in 60 GHz based systems allows for small antenna dimensions that enable multiple antenna systems, such as phased arrays.

The 60 GHz antenna form factor is on the order of millimeters, which requires advanced integration techniques for packaging. Routing signals from a chipset source to an antenna is also problematic. There may also be competing requirements between the antenna and the support circuitry. For example, the antenna may need a substrate with low permittivity and high relative thickness to obtain the greatest efficiency, a wide bandwidth, an undisturbed radiation pattern, and less coupling to other components. Conversely, the radio frequency (RF) components may require thin materials with high permittivity for compactness, better signal transmission, and better thermal dissipation.

There are various types of antennas. One such antenna, a substrate integrated waveguide (SIW) uses periodic metallic vias to form a waveguide structure in printed circuit boards (PCBs) or low-temperature co-fired ceramics (LTCCs).

### BRIEF DESCRIPTION OF THE DRAWINGS

The present disclosure may be understood, and its numerous objects, features and advantages obtained, when the following detailed description is considered in conjunction with the following drawings, in which:

FIG. 1 depicts an exemplary system in which the present disclosure may be implemented;

FIG. 2 shows a wireless-enabled communications environment including an embodiment of a client node;

FIG. 3 is a simplified block diagram of an exemplary client node comprising a digital signal processor (DSP);

FIG. 4 illustrates an ideal horn antenna in free space;

FIG. 5 illustrates a S11 reflection coefficient for the horn antenna of FIG. 4;

FIG. 6A illustrates a three-dimensional (3D) radiation pattern for the horn antenna of FIG. 4;

FIG. 6B illustrates an E plane radiation pattern for the horn antenna of FIG. 4;

FIG. 7 illustrates a horn antenna embedded in a substrate;

FIG. 8 illustrates a S11 reflection coefficient for the horn antenna of FIG. 7,

FIG. 9A illustrates a 3D radiation pattern for the horn antenna of FIG. 7;

FIG. 9B illustrates an E plane radiation pattern for the horn antenna of FIG. 7;

FIG. 10 illustrates a horn antenna embedded in a two-layer substrate;

FIG. 11 illustrates a S11 reflection coefficient for the horn antenna of FIG. 10;

FIG. 12A illustrates a 3D radiation pattern for the horn antenna of FIG. 10;

FIG. 12B illustrates an E plane radiation pattern for the horn antenna of FIG. 10;

FIG. 13 illustrates a substrate integrated waveguide (SIW) horn antenna in free space;

FIG. 14 illustrates a S11 reflection coefficient for the SIW horn antenna of FIG. 13;

FIG. 15A illustrates a 3D radiation pattern for the SIW horn antenna of FIG. 13;

FIG. 15B illustrates an E plane radiation pattern for the SIW horn antenna of FIG. 13;

FIG. 16 illustrates a SIW horn antenna embedded in a substrate;

FIG. 17 illustrates a S11 reflection coefficient for the SIW horn antenna of FIG. 16;

FIG. 18A illustrates a 3D radiation pattern for the SIW horn antenna of FIG. 16;

FIG. 18B illustrates an E plane radiation pattern for the SIW horn antenna of FIG. 16;

FIG. 19A illustrates a SIW horn antenna embedded in a two-layer substrate of the same or different permittivity;

FIG. 19B illustrates a top view of the SIW horn antenna of FIG. 19A;

FIG. 20 illustrates a S11 reflection coefficient for the SIW horn antenna of FIG. 19A;

FIG. 21A illustrates a 3D radiation pattern for the SIW horn antenna of FIG. 19A;

FIG. 21B illustrates an E plane radiation pattern for the SIW horn antenna of FIG. 19A;

FIGS. 22A-22C illustrate a S11 reflection coefficient for SIW antennas;

FIGS. 23A-23C illustrate E plane radiation patterns for SIW antennas;

FIGS. 24A-24C illustrate E filed distributions for SIW antennas;

FIG. 25A illustrates a half SIW horn antenna;

FIG. 25B illustrates a full SIW horn antenna;

FIG. 26 illustrates a microstrip-to-an ideal horn antenna transition;

FIG. 27 illustrates a S11 reflection coefficient for the SIW antenna of FIG. 26;

FIG. 28 illustrates an E field distribution for the SIW antenna of FIG. 26;

FIG. 29 illustrates a microstrip-to-an ideal horn antenna transition with parallel guiding walls;

FIG. 30 illustrates a S11 reflection coefficient for the SIW antenna of FIG. 29;

FIG. 31 illustrates an E field distribution for the SIW antenna of FIG. 29;

FIG. 32 illustrates a microstrip-to-an ideal horn antenna transition with tilted parallel guiding walls;

FIG. 33 illustrates a Si i reflection coefficient for the SIW antenna of FIG. 32;

FIG. 34 illustrates an E field distribution for the SIW antenna of FIG. 32;

FIG. 35 illustrates a microstrip-to-an ideal horn antenna transition with multiple parallel guiding walls;

FIG. 36 illustrates a S11 reflection coefficient for the SIW antenna of FIG. 35;

FIG. 37 illustrates an E field distribution for the SIW antenna of FIG. 35;

FIG. 38 illustrates a curved tapered microstrip-to-an ideal horn antenna transition with multiple parallel guiding walls;

FIG. 39 illustrates a S11 reflection coefficient for the SIW antenna of FIG. 38;

FIG. 40 illustrates an E field distribution for the SIW antenna of FIG. 38;

FIG. 41 illustrates a SIW version of the transition of FIG. 38 for both an ideal horn and transition;

FIG. 42 illustrates a S11 reflection coefficient for the SIW antenna of FIG. 41;

FIG. 43 illustrates an E field distribution for the SIW antenna of FIG. 41;

FIG. 44 illustrates a 3D far field radiation pattern for the SIW antenna of FIG. 41;

FIG. 45 illustrates a flow chart of an exemplary method; and

FIG. 46 illustrates a flow chart of an exemplary method.

### DETAILED DESCRIPTION

The present disclosure is directed in general to communications systems and methods for operating the same.

Embodiments are directed to a substrate integrated waveguide (SIW) antenna structure comprising: a first layer configured to route a signal, at least a second layer configured for antenna use coupled to the first layer, and a SIW antenna flared in the E-plane.

Embodiments are directed to a method comprising: fabricating a first layer configured to route a signal, fabricating at least a second layer configured for antenna use, coupling the first layer and the at least a second layer, and flaring a substrate integrated waveguide (SIW) antenna in the E-plane.

Embodiments are directed to a transition structure comprising: a microstrip line, an antenna, and a transition configured to connect the microstrip line to the antenna, wherein the transition comprises a taper that narrows from the antenna to the microstrip line.

Embodiments are directed to a structure comprising: a microstrip transition, a horn antenna coupled to the microstrip transition, and a plurality of guide walls configured to guide a wave in a transition between the microstrip transition and the horn antenna.

Embodiments are directed to a method comprising: identifying a transition from a microstrip line to a substrate integrated waveguide (SIW) horn antenna structure configured to operate at 60 GHz, and selecting a geometry for the transition.

Various illustrative embodiments of the present disclosure will now be described in detail with reference to the accompanying figures. While various details are set forth in the following description, it will be appreciated that the present disclosure may be practiced without these specific details, and that numerous implementation-specific decisions may be made to the disclosure described herein to achieve specific goals, such as compliance with process technology or design-related constraints, which will vary from one implementation to another. While such a development effort might be complex and time-consuming, it would nevertheless be a routine undertaking for those of skill in the art having the benefit of this disclosure. For example, selected aspects are shown in block diagram and flowchart form, rather than in detail, in order to avoid limiting or obscuring the present disclosure. In addition, some portions of the detailed descriptions provided herein are presented in terms of algorithms or operations on data within a computer memory. Such descriptions and representations are used by those skilled in the art to describe and convey the substance of their work to others skilled in the art.

As used herein, the terms “component,” “system” and the like are intended to refer to a computer-related entity, either hardware, software, a combination of hardware and software, or software in execution. For example, a component may be, but is not limited to being, a processor, a process running on a processor, an object, an executable instruction sequence, a thread of execution, a program, or a computer. By way of illustration, both an application running on a computer and the computer itself can be a component. One or more components may reside within a process or thread of execution and a component may be localized on one computer or distributed between two or more computers.

As likewise used herein, the term “node” broadly refers to a connection point, such as a redistribution point or a communication endpoint, of a communication environment, such as a network. Accordingly, such nodes refer to an active electronic device capable of sending, receiving, or forwarding information over a communications channel. Examples of such nodes include data circuit-terminating equipment (DCE), such as a modem, hub, bridge or switch, and data terminal equipment (DTE), such as a handset, a printer or a host computer (e.g., a router, workstation or server). Examples of local area network (LAN) or wide area network (WAN) nodes include computers, packet switches, cable modems, Data Subscriber Line (DSL) modems, and wireless LAN (WLAN) access points. Examples of Internet or Intranet nodes include host computers identified by an Internet Protocol (IP) address, bridges and WLAN access points. Likewise, examples of nodes in cellular communication include base stations, relays, base station controllers, radio network controllers, home location registers (HLR), visited location registers (VLR), Gateway GPRS Support Nodes (GGSN), Serving GPRS Support Nodes (SGSN), Serving Gateways (S-GW), and Packet Data Network Gateways (PDN-GW).

Other examples of nodes include client nodes, server nodes, peer nodes and access nodes. As used herein, a client node may refer to wireless devices such as mobile telephones, smart phones, personal digital assistants (PDAs), handheld devices, portable computers, tablet computers, and similar devices or other user equipment (UE) that has telecommunications capabilities. Such client nodes may likewise refer to a mobile, wireless device, or alternatively, to devices that have similar capabilities that are not generally transportable, such as desktop computers, set-top boxes, or sensors. A network node, as used herein, generally includes all nodes with the exception of client nodes, server nodes and access nodes. Likewise, a server node, as used herein, refers to an information processing device (e.g., a host computer), or series of information processing devices, that perform information processing requests submitted by other nodes. As likewise used herein, a peer node may sometimes serve as client node, and at other times, a server node. In a peer-to-peer or overlay network, a node that actively routes data for other networked devices as well as itself may be referred to as a supernode.

An access node, as used herein, refers to a node that provides a client node access to a communication environment. Examples of access nodes include cellular network base stations and wireless broadband (e.g., WiFi, WiMAX, etc.) access points, which provide corresponding cell and WLAN coverage areas. WiGig® and its equivalents in the greater than 50 GHz range are also examples of wireless broadband. As used herein, a macrocell is used to generally describe a traditional cellular network cell coverage area. Such macrocells are typically found in rural areas, along highways, or in less populated areas. As likewise used herein, a microcell refers to a cellular network cell with a smaller coverage area than that of a macrocell. Such micro cells are typically used in a densely populated urban area. Likewise, as used herein, a picocell refers to a cellular network coverage area that is less than that of a microcell. An example of the coverage area of a picocell may be a large office, a shopping mall, or a train station. A femtocell, as used herein, currently refers to the smallest commonly accepted area of cellular network coverage. As an example, the coverage area of a femtocell is sufficient for homes or small offices.

In general, a coverage area of less than two kilometers typically corresponds to a microcell, 200 meters or less for a picocell, and on the order of 10 meters for a femtocell. The actual dimensions of the cell may depend on the radio frequency of operation, the radio propagation conditions and the density of communications traffic. As likewise used herein, a client node communicating with an access node associated with a macrocell is referred to as a “macrocell client.” Likewise, a client node communicating with an access node associated with a microcell, picocell, or femtocell is respectively referred to as a “microcell client,” “picocell client,” or “femtocell client.”

The term “article of manufacture” (or alternatively, “computer program product”) as used herein is intended to encompass a computer program accessible from any computer-readable device or media. For example, computer readable media can include but are not limited to magnetic storage devices (e.g., hard disk, floppy disk, magnetic strips, etc.), optical disks such as a compact disk (CD) or digital versatile disk (DVD), smart cards, and flash memory devices (e.g., card, stick, etc.).

The word “exemplary” is used herein to mean serving as an example, instance, or illustration. Any aspect or design described herein as “exemplary” is not necessarily to be construed as preferred or advantageous over other aspects or designs. Those of skill in the art will recognize many modifications may be made to this configuration without departing from the scope, spirit or intent of the claimed subject matter. Furthermore, the disclosed subject matter may be implemented as a system, method, apparatus, or article of manufacture using standard programming and engineering techniques to produce software, firmware, hardware, or any combination thereof to control a computer or processor-based device to implement aspects detailed herein.

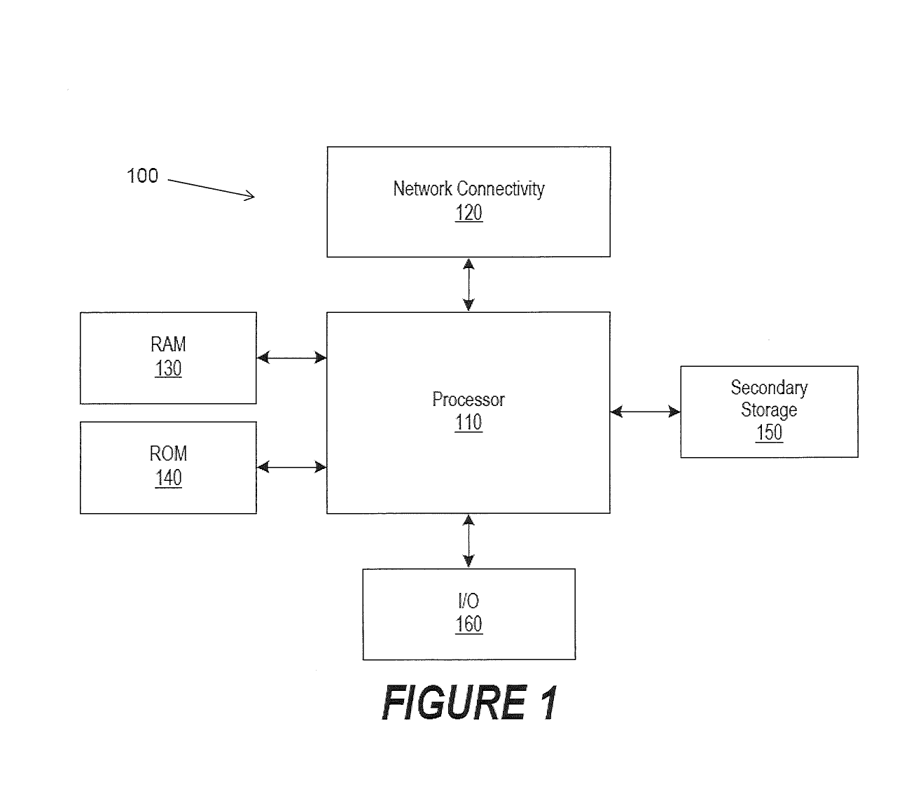

FIG. 1 illustrates an example of a system 100 suitable for implementing one or more embodiments disclosed herein. In various embodiments, the system 100 comprises a processor 110, which may be referred to as a central processor unit (CPU) or digital signal processor (DSP), network connectivity interfaces 120, random access memory (RAM) 130, read only memory (ROM) 140, secondary storage 150, and input/output (I/O) devices 160. In some embodiments, some of these components may not be present or may be combined in various combinations with one another or with other components not shown. These components may be located in a single physical entity or in more than one physical entity. Any actions described herein as being taken by the processor 110 might be taken by the processor 110 alone or by the processor 110 in conjunction with one or more components shown or not shown in FIG. 1.

The processor 110 executes instructions, codes, computer programs, or scripts that it might access from the network connectivity interfaces 120, RAM 130, or ROM 140. While only one processor 110 is shown, multiple processors may be present. Thus, while instructions may be discussed as being executed by a processor 110, the instructions may be executed simultaneously, serially, or otherwise by one or multiple processors 110 implemented as one or more CPU chips.

In various embodiments, the network connectivity interfaces 120 may take the form of modems, modem banks, Ethernet devices, universal serial bus (USB) interface devices, serial interfaces, token ring devices, fiber distributed data interface (FDDI) devices, wireless local area network (WLAN) devices (including radio, optical or infra-red signals), radio transceiver devices such as code division multiple access (CDMA) devices, global system for mobile communications (GSM) radio transceiver devices, long term evolution (LTE) radio transceiver devices, worldwide interoperability for microwave access (WiMAX) devices, and/or other well-known interfaces for connecting to networks, including Personal Area Networks (PANs) such as Bluetooth. These network connectivity interfaces 120 may enable the processor 110 to communicate with the Internet or one or more telecommunications networks or other networks from which the processor 110 might receive information or to which the processor 110 might output information.

The network connectivity interfaces 120 may also be capable of transmitting or receiving data wirelessly in the form of electromagnetic waves, such as radio frequency signals or microwave frequency signals. Information transmitted or received by the network connectivity interfaces 120 may include data that has been processed by the processor 110 or instructions that are to be executed by processor 110. The data may be ordered according to different sequences as may be desirable for either processing or generating the data or transmitting or receiving the data.

In various embodiments, the RAM 130 may be used to store volatile data and instructions that are executed by the processor 110. The ROM 140 shown in FIG. 1 may likewise be used to store instructions and data that is read during execution of the instructions. The secondary storage 150 is typically comprised of one or more disk drives, solid state drives, or tape drives and may be used for non-volatile storage of data or as an overflow data storage device if RAM 130 is not large enough to hold all working data. Secondary storage 150 may likewise be used to store programs that are loaded into RAM 130 when such programs are selected for execution. The I/O devices 160 may include liquid crystal displays (LCDs), Light Emitting Diode (LED) displays, Organic Light Emitting Diode (OLED) displays, projectors, televisions, touch screen displays, keyboards, keypads, switches, dials, mice, track balls, track pads, voice recognizers, card readers, paper tape readers, printers, video monitors, or other well-known input/output devices.

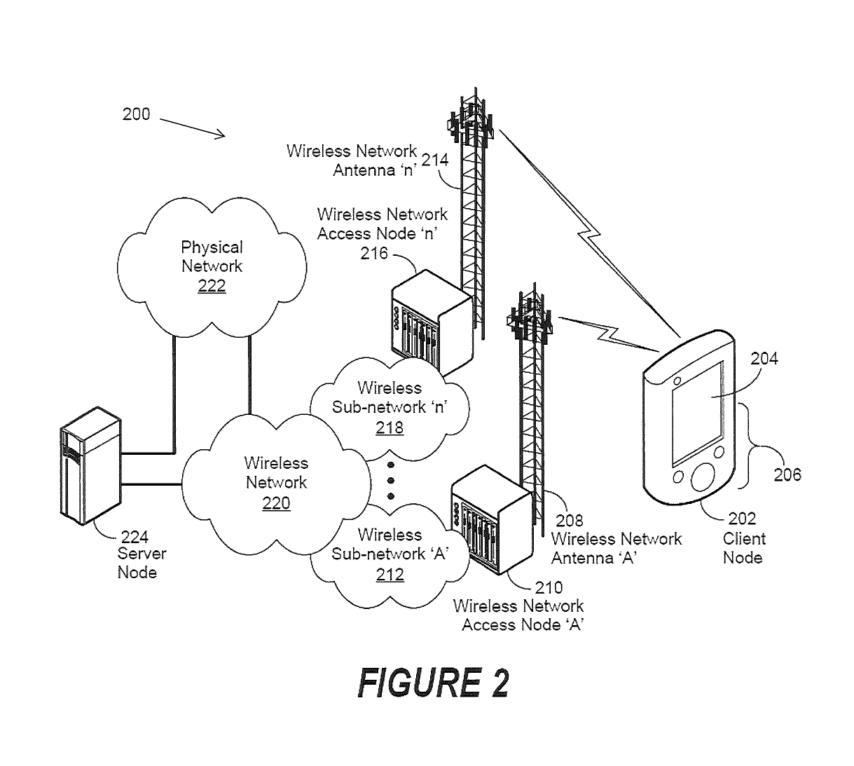

FIG. 2 shows a wireless-enabled communications environment including an embodiment of a client node as implemented in an embodiment of the disclosure. Though illustrated as a mobile phone, the client node 202 may take various forms including a wireless handset, a pager, a smart phone, or a personal digital assistant (PDA). In various embodiments, the client node 202 may also comprise a portable computer, a tablet computer, a laptop computer, or any computing device operable to perform data communication operations. Many suitable devices combine some or all of these functions. In some embodiments, the client node 202 is not a general purpose computing device like a portable, laptop, or tablet computer, but rather is a special-purpose communications device such as a telecommunications device installed in a vehicle. The client node 202 may likewise be a device, include a device, or be included in a device that has similar capabilities but that is not transportable, such as a desktop computer, a set-top box, or a network node. In these and other embodiments, the client node 202 may support specialized activities such as gaming, inventory control, job control, task management functions, and so forth.

In various embodiments, the client node 202 includes a display 204. In these and other embodiments, the client node 202 may likewise include a touch-sensitive surface, a keyboard or other input keys 206 generally used for input by a user. The input keys 206 may likewise be a full or reduced alphanumeric keyboard such as QWERTY, DVORAK, AZERTY, and sequential keyboard types, or a traditional numeric keypad with alphabet letters associated with a telephone keypad. The input keys 206 may likewise include a trackwheel, an exit or escape key, a trackball, trackpad, touch sensitive input device and other navigational or functional keys, which may be moved to different positions, e.g., inwardly depressed, to provide further input function. The client node 202 may likewise present options for the user to select, controls for the user to actuate, and cursors or other indicators for the user to direct.

The client node 202 may further accept data entry from the user, including numbers to dial or various parameter values for configuring the operation of the client node 202. The client node 202 may further execute one or more software or firmware applications in response to user commands. These applications may configure the client node 202 to perform various customized functions in response to user interaction. Additionally, the client node 202 may be programmed or configured over-the-air (OTA), for example from a wireless network access node ‘A’ 210 through ‘n’ 216 (e.g., a base station), a server node 224 (e.g., a host computer), or a peer client node 202.

Among the various applications executable by the client node 202 are a web browser, which enables the display 204 to display a web page. The web page may be obtained from a server node 224 through a wireless connection with a wireless network 220. As used herein, a wireless network 220 broadly refers to any network using at least one wireless connection between two of its nodes. The various applications may likewise be obtained from a peer client node 202 or other system over a connection to the wireless network 220 or any other wirelessly-enabled communication network or system.

In various embodiments, the wireless network 220 comprises a plurality of wireless sub-networks (e.g., cells with corresponding coverage areas) ‘A’ 212 through ‘n’ 218. As used herein, the wireless sub-networks ‘A’ 212 through ‘n’ 218 may variously comprise a mobile wireless access network or a fixed wireless access network. In these and other embodiments, the client node 202 transmits and receives communication signals, which are respectively communicated to and from the wireless network nodes ‘A’ 210 through ‘n’ 216 by wireless network antennas ‘A’ 208 through ‘n’ 214 (e.g., cell towers). In turn, the communication signals are used by the wireless network access nodes ‘A’ 210 through ‘n’ 216 to establish a wireless communication session with the client node 202. As used herein, the network access nodes ‘A’ 210 through ‘n’ 216 broadly refer to any access node of a wireless network. As shown in FIG. 2, the wireless network access nodes ‘A’ 210 through ‘n’ 216 are respectively coupled to wireless sub-networks ‘A’ 212 through ‘n’ 218, which are in turn connected to the wireless network 220.

In various embodiments, the wireless network 220 is coupled to a core network 222, e.g., a global computer network such as the Internet. Via the wireless network 220 and the core network 222, the client node 202 has access to information on various hosts, such as the server node 224. In these and other embodiments, the server node 224 may provide content that may be shown on the display 204 or used by the client node processor 110 for its operations. Alternatively, the client node 202 may access the wireless network 220 through a peer client node 202 acting as an intermediary, in a relay type or hop type of connection. As another alternative, the client node 202 may be tethered and obtain its data from a linked device that is connected to the wireless sub-network 212. Skilled practitioners of the art will recognize that many such embodiments are possible and the foregoing is not intended to limit the spirit, scope, or intention of the disclosure.

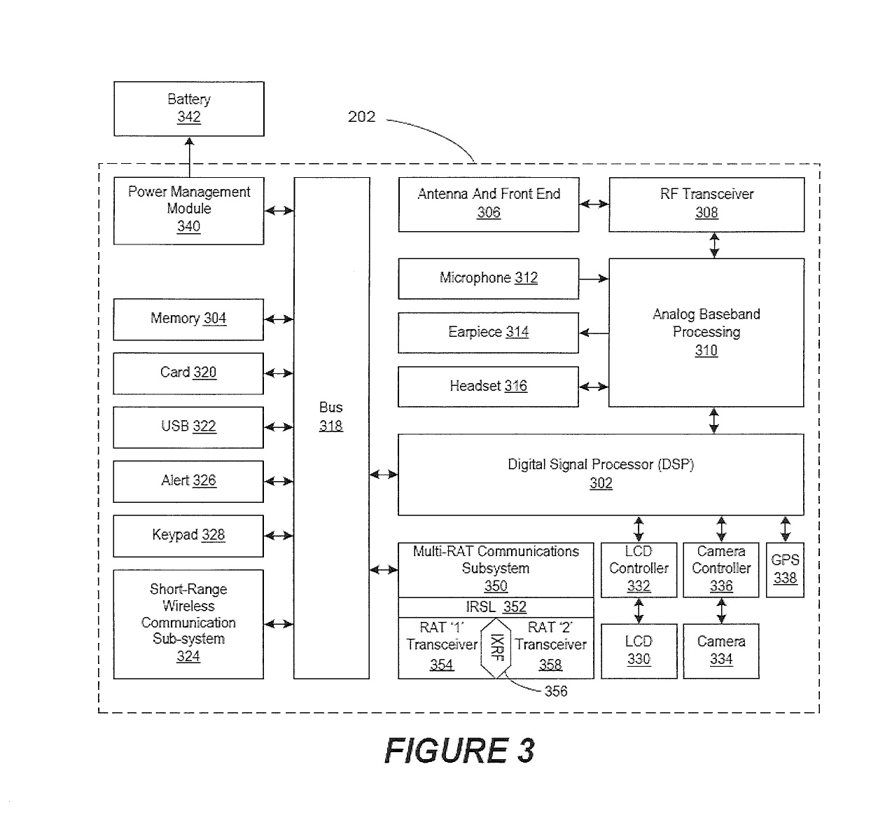

FIG. 3 depicts a block diagram of an exemplary client node as implemented with a digital signal processor (DSP) in accordance with an embodiment of the disclosure. While various components of a client node 202 are depicted, various embodiments of the client node 202 may include a subset of the listed components or additional components not listed. As shown in FIG. 3, the client node 202 includes a DSP 302 and a memory 304. As shown, the client node 202 may further include an antenna and front end unit 306, a radio frequency (RF) transceiver 308, an analog baseband processing unit 310, a microphone 312, an earpiece speaker 314, a headset port 316, a bus 318, such as a system bus or an input/output (I/O) interface bus, a removable memory card 320, a universal serial bus (USB) port 322, a short range wireless communication sub-system 324, an alert 326, a keypad 328, a liquid crystal display (LCD) 330, which may include a touch sensitive surface, an LCD controller 332, a charge-coupled device (CCD) camera 334, a camera controller 336, and a global positioning system (GPS) sensor 338, and a power management module 340 operably coupled to a power storage unit, such as a battery 342. In various embodiments, the client node 202 may include another kind of display that does not provide a touch sensitive screen. In one embodiment, the DSP 302 communicates directly with the memory 304 without passing through the input/output interface (“Bus”) 318.

In various embodiments, the DSP 302 or some other form of controller or central processing unit (CPU) operates to control the various components of the client node 202 in accordance with embedded software or firmware stored in memory 304 or stored in memory contained within the DSP 302 itself. In addition to the embedded software or firmware, the DSP 302 may execute other applications stored in the memory 304 or made available via information media such as portable data storage media like the removable memory card 320 or via wired or wireless network communications. The application software may comprise a compiled set of machine-readable instructions that configure the DSP 302 to provide the desired functionality, or the application software may be high-level software instructions to be processed by an interpreter or compiler to indirectly configure the DSP 302.

The antenna and front end unit 306 may be provided to convert between wireless signals and electrical signals, enabling the client node 202 to send and receive information from a cellular network or some other available wireless communications network or from a peer client node 202. In an embodiment, the antenna and front end unit 106 may include multiple antennas to support beam forming and/or multiple input multiple output (MIMO) operations. As is known to those skilled in the art, MIMO operations may provide spatial diversity, which can be used to overcome difficult channel conditions or to increase channel throughput. Likewise, the antenna and front-end unit 306 may include antenna tuning or impedance matching components, RF power amplifiers, or low noise amplifiers.

In various embodiments, the RF transceiver 308 provides frequency shifting; converting received RF signals to baseband and converting baseband transmit signals to RF. In some descriptions a radio transceiver or RF transceiver may be understood to include other signal processing functionality such as modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions. For the purposes of clarity, the description here separates the description of this signal processing from the RF and/or radio stage and conceptually allocates that signal processing to the analog baseband processing unit 310 or the DSP 302 or other central processing unit. In some embodiments, the RF Transceiver 108, portions of the Antenna and Front End 306, and the analog base band processing unit 310 may be combined in one or more processing units and/or application specific integrated circuits (ASICs).

Note that in this diagram the radio access technology (RAT) RAT1 and RAT2 transceivers 354, 358, the IXRF 356, the IRSL 352 and Multi-RAT subsystem 350 are operably coupled to the RF transceiver 308 and analog baseband processing unit 310 and then also coupled to the antenna and front end 306 via the RF transceiver 308. As there may be multiple RAT transceivers, there will typically be multiple antennas or front ends 306 or RF transceivers 308, one for each RAT or band of operation.

The analog baseband processing unit 310 may provide various analog processing of inputs and outputs for the RF transceivers 308 and the speech interfaces (312, 314, 316). For example, the analog baseband processing unit 310 receives inputs from the microphone 312 and the headset 316 and provides outputs to the earpiece 314 and the headset 316. To that end, the analog baseband processing unit 310 may have ports for connecting to the built-in microphone 312 and the earpiece speaker 314 that enable the client node 202 to be used as a cell phone. The analog baseband processing unit 310 may further include a port for connecting to a headset or other hands-free microphone and speaker configuration. The analog baseband processing unit 310 may provide digital-to-analog conversion in one signal direction and analog-to-digital conversion in the opposing signal direction. In various embodiments, at least some of the functionality of the analog baseband processing unit 310 may be provided by digital processing components, for example by the DSP 302 or by other central processing units.

The DSP 302 may perform modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions associated with wireless communications. In an embodiment, for example in a code division multiple access (CDMA) technology application, for a transmitter function the DSP 302 may perform modulation, coding, interleaving, and spreading, and for a receiver function the DSP 302 may perform despreading, deinterleaving, decoding, and demodulation. In another embodiment, for example in an orthogonal frequency division multiplex access (OFDMA) technology application, for the transmitter function the DSP 302 may perform modulation, coding, interleaving, inverse fast Fourier transforming, and cyclic prefix appending, and for a receiver function the DSP 302 may perform cyclic prefix removal, fast Fourier transforming, deinterleaving, decoding, and demodulation. In other wireless technology applications, yet other signal processing functions and combinations of signal processing functions may be performed by the DSP 302.

The DSP 302 may communicate with a wireless network via the analog baseband processing unit 310. In some embodiments, the communication may provide Internet connectivity, enabling a user to gain access to content on the Internet and to send and receive e-mail or text messages. The input/output interface 318 interconnects the DSP 302 and various memories and interfaces. The memory 304 and the removable memory card 320 may provide software and data to configure the operation of the DSP 302. Among the interfaces may be the USB interface 322 and the short range wireless communication sub-system 324. The USB interface 322 may be used to charge the client node 202 and may also enable the client node 202 to function as a peripheral device to exchange information with a personal computer or other computer system. The short range wireless communication sub-system 324 may include an infrared port, a Bluetooth interface, an IEEE 802.11 compliant wireless interface, or any other short range wireless communication sub-system, which may enable the client node 202 to communicate wirelessly with other nearby client nodes and access nodes. The short-range wireless communication Sub-system 324 may also include suitable RF Transceiver, Antenna and Front End subsystems.

The input/output interface (“Bus”) 318 may further connect the DSP 302 to the alert 326 that, when triggered, causes the client node 202 to provide a notice to the user, for example, by ringing, playing a melody, or vibrating. The alert 326 may serve as a mechanism for alerting the user to any of various events such as an incoming call, a new text message, and an appointment reminder by silently vibrating, or by playing a specific pre-assigned melody for a particular caller.

The keypad 328 couples to the DSP 302 via the I/O interface (“Bus”) 318 to provide one mechanism for the user to make selections, enter information, and otherwise provide input to the client node 202. The keyboard 328 may be a full or reduced alphanumeric keyboard such as QWERTY, DVORAK, AZERTY and sequential types, or a traditional numeric keypad with alphabet letters associated with a telephone keypad. The input keys may likewise include a trackwheel, track pad, an exit or escape key, a trackball, and other navigational or functional keys, which may be inwardly depressed to provide further input function. Another input mechanism may be the LCD 330, which may include touch screen capability and also display text and/or graphics to the user. The LCD controller 332 couples the DSP 302 to the LCD 330.

The CCD camera 334, if equipped, enables the client node 202 to make digital pictures. The DSP 302 communicates with the CCD camera 334 via the camera controller 336. In another embodiment, a camera operating according to a technology other than Charge Coupled Device cameras may be employed. The GPS sensor 338 is coupled to the DSP 302 to decode global positioning system signals or other navigational signals, thereby enabling the client node 202 to determine its position. The GPS sensor 338 may be coupled to an antenna and front end (not shown) suitable for its band of operation. Various other peripherals may also be included to provide additional functions, such as radio and television reception.

In various embodiments, the client node (e.g., 202) comprises a first Radio Access Technology (RAT) transceiver 354 and a second RAT transceiver 358. As shown in FIG. 3, and described in greater detail herein, the RAT transceivers ‘1’ 354 and ‘2’ 358 are in turn coupled to a multi-RAT communications subsystem 350 by an Inter-RAT Supervisory Layer Module 352. In turn, the multi-RAT communications subsystem 350 is operably coupled to the Bus 318. Optionally, the respective radio protocol layers of the first Radio Access Technology (RAT) transceiver 354 and the second RAT transceiver 358 are operably coupled to one another through an Inter-RAT eXchange Function (IRXF) Module 356.

In various embodiments, the network node (e.g. 224) acting as a server comprises a first communication link corresponding to data to/from the first RAT and a second communication link corresponding to data to/from the second RAT.

Embodiments of the disclosure may also include a housing in which the components of FIG. 3 are secured. In an example, the antenna, which can be part of the antenna and front end 306, is positioned in the housing. The antenna might not be readily visible or distinguishable from the housing. One or more slots may be available in the housing to support the antenna. In an example, the antenna can be mostly positioned in the side of the housing. In an example, the antenna can be at least partially positioned in a trackpad, display, or touchscreen of a device (e.g., a mobile device).

Embodiments of the disclosure may be operative at one or more frequencies. For example, communication may occur at 60 GHz (which may be divided into one or more channels or bands, such as a first channel between 57.24 GHz and 59.4 GHz, a second channel between 59.4 GHz and 61.56 GHz, a third channel between 61.56 GHz and 63.72 GHz, and a fourth channel between 63.72 GHz and 65.88 GHz). In some embodiments, an antenna may achieve communication in a range of 60 GHZ, +/−5 GHz or +/−6 GHz.

Embodiments of the disclosure are directed to one or more systems, apparatuses, devices, and methods for making and using a substrate integrated waveguide (SIW) horn antenna structure. In some embodiments, the SIW antenna may be flared in one or more planes, such as in the E plane, the H plane, or in both E and H planes. The axis of the SIW horn antenna may be perpendicular to a PCB/LTCC surface. The SIW horn antenna can occupy one or multiple substrate layers and extend in the perpendicular direction of the PCB/LTCC in a stair-cased fashion. This would considerably increase the horn aperture, which may consequently increase the antenna gain. Considering a small wavelength at 60 GHz operation, the total thickness might not be a major concern. Also, the described structure can increase the antenna gain in a similar antenna volume compared to conventional techniques (e.g., the use of a dipole), since its geometry may better represent a horn antenna.

In some embodiments, a SIW horn antenna may be excited with a microstrip line that occupies a thin substrate layer. Since the SIW horn antenna may occupy multiple layers of substrates that may have different dielectric constants, one thin layer can be used for a 60 GHz signal. One or more of the layers may be used for antenna purposes. Accordingly, a transition of an excitation signal from other types of transmission lines to a probe pin may be avoided, thereby eliminating or reducing unwanted wave modes.

In some embodiments, such as those where a SIW horn antenna occupies multiple layers of substrates and forms a stair-cased structure, wave reflections may occur at the boundary of the stairs and unwanted modes can be excited. Matching posts may be used to mitigate against unwanted modes. The three-dimensional (3D) positions of the posts may be tuned to achieve best or optimum antenna performance. The shape of the SIW horn antenna may be optimized to generate minimal reflections.

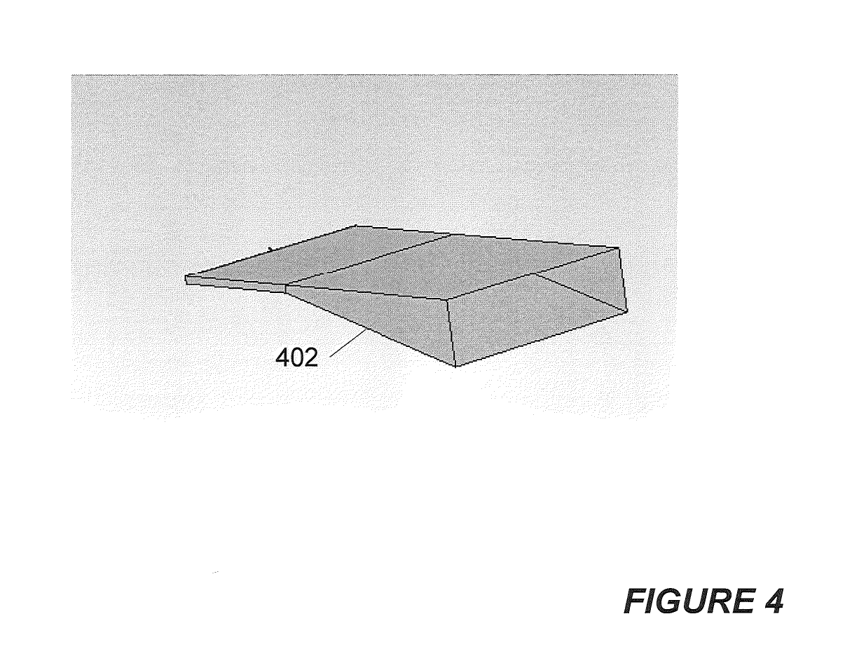

Referring to FIG. 4, a horn structure 402 in accordance with one or more embodiments is shown. The horn 402 may correspond to an ideal “half” horn antenna in free space. In one embodiment, the horn 402 may have dimensions of 2.8 mm×4.9 mm×0.8 mm.

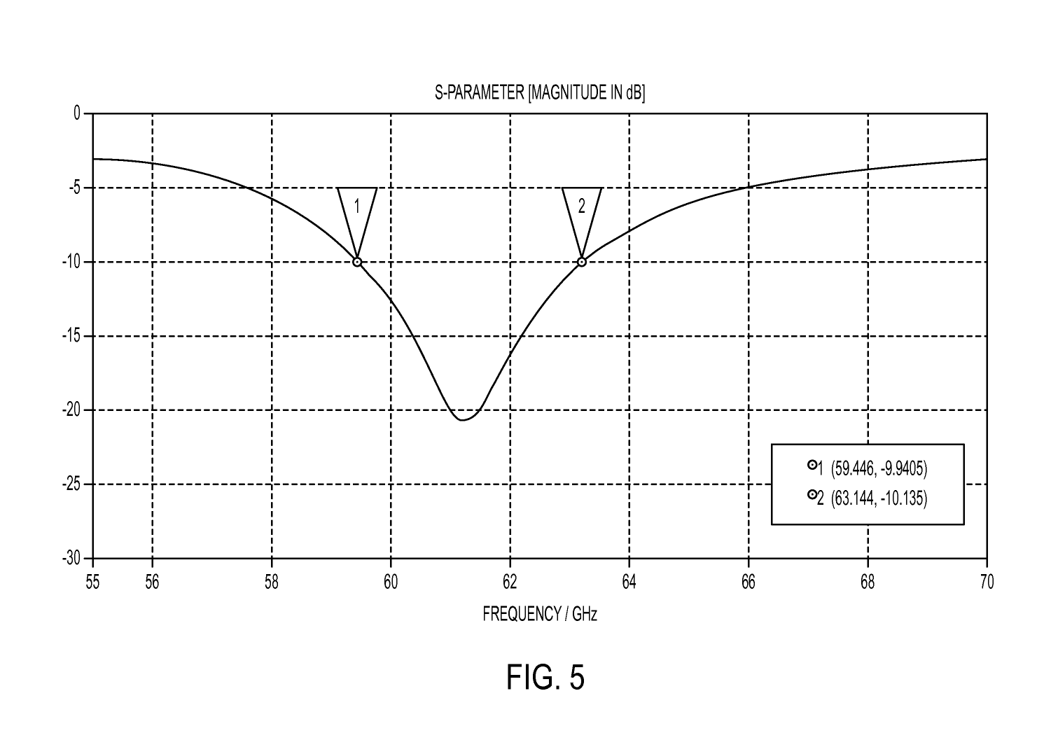

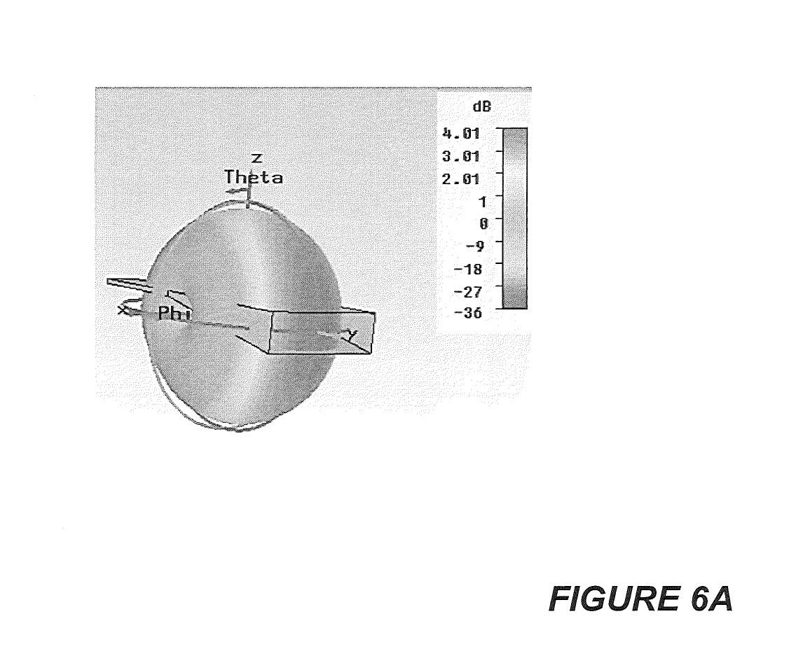

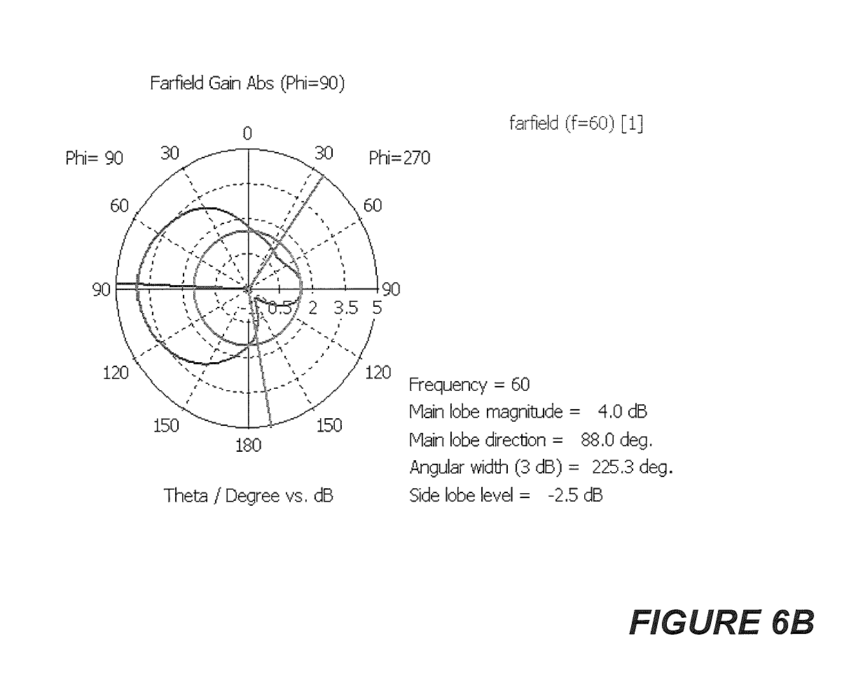

A reflection coefficient for the horn 402 is shown in FIG. 5 and radiation patterns are shown in FIGS. 6A-6B. It is shown that a bandwidth of approximately 4 GHz and a maximum gain of approximately 4 dB may be obtained.

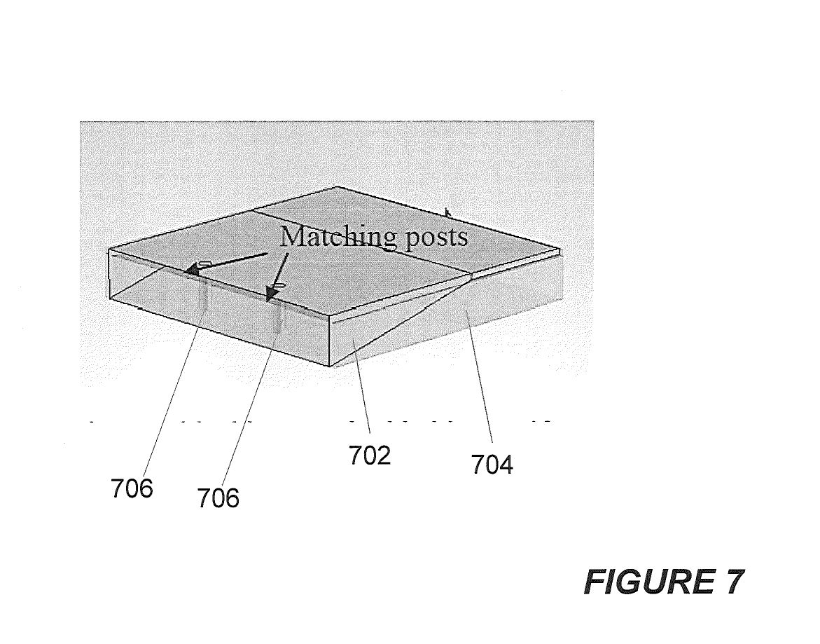

Referring to FIG. 7, a horn structure 702 embedded in a substrate 704 is shown. The horn structure 702 may correspond to the horn 402 of FIG. 4. In one embodiment, the horn 702 may have dimensions of 5 mm×4.9 mm×0.8 mm. The substrate 704 may be a uniform substrate. The substrate may, for example, be Pyralux TK with a relative permittivity of 2.5 and a loss tangent of 0.002.

The horn structure 702 may be associated with one or more matching posts 706. The positions of the posts 706 may be selected to obtain a particular antenna performance (e.g., optimum antenna performance).

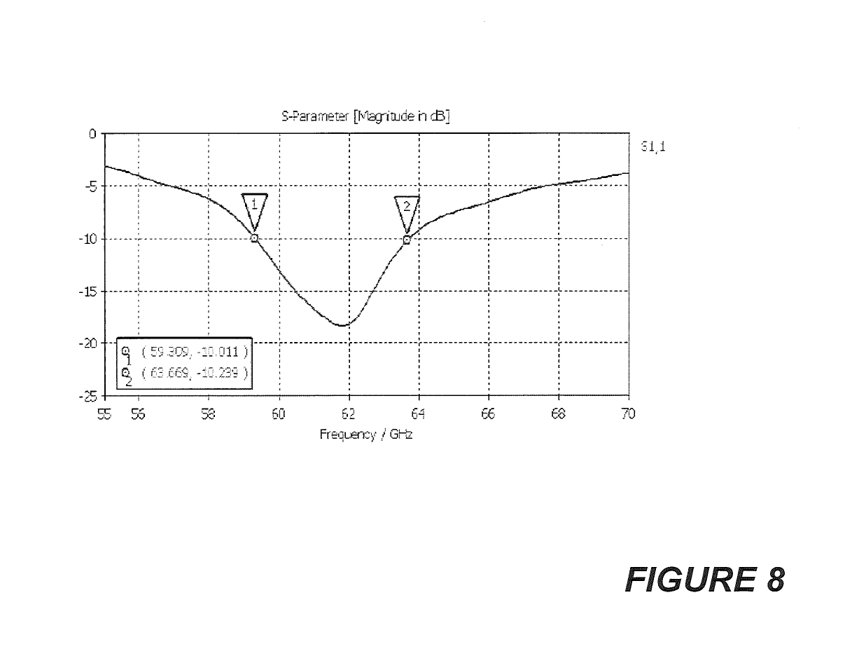

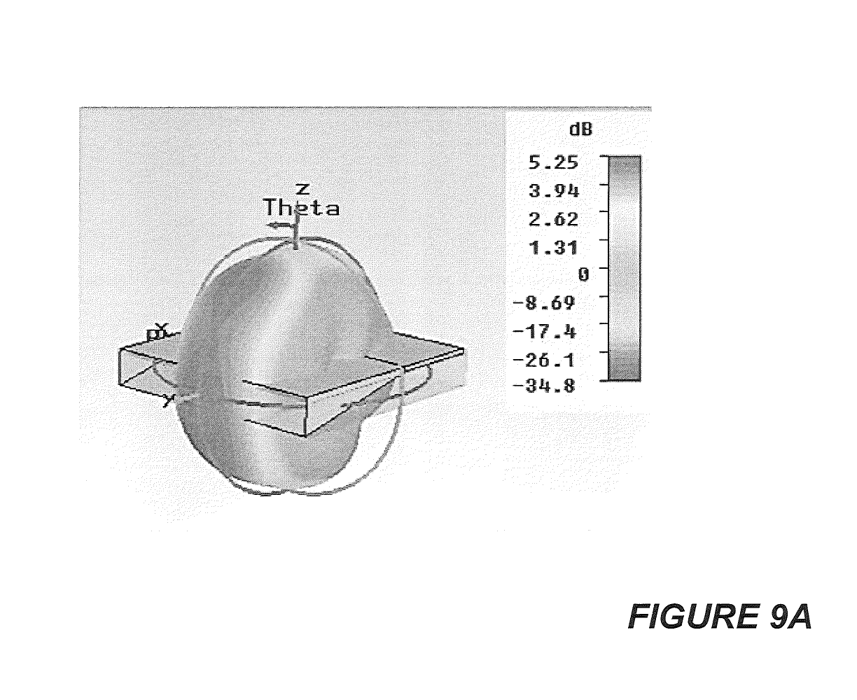

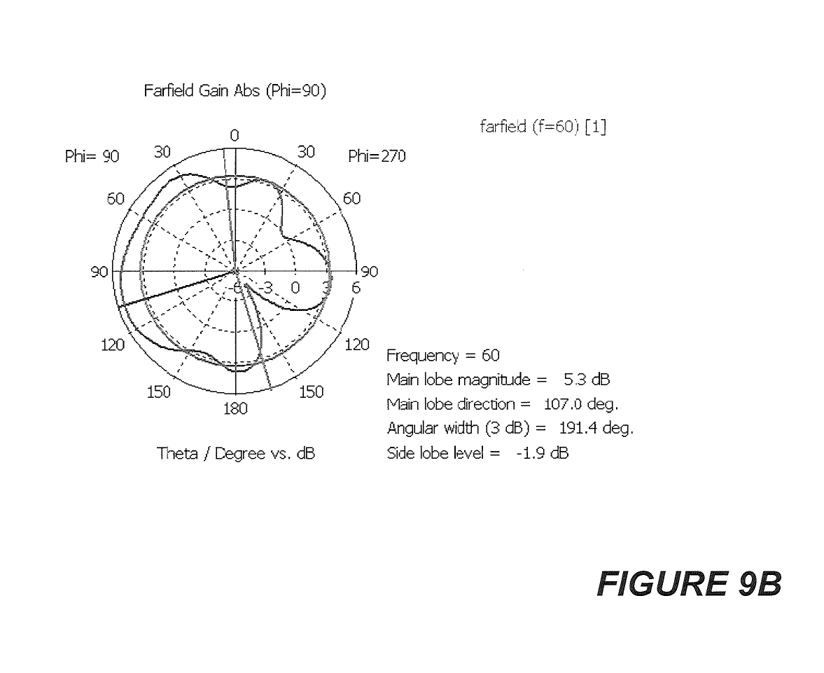

A reflection coefficient for the horn 702 is shown in FIG. 8 and radiation patterns are shown in FIGS. 9A-9B. It is shown that a bandwidth of approximately 4 GHz and a maximum gain of approximately 5.25 dB may be obtained.

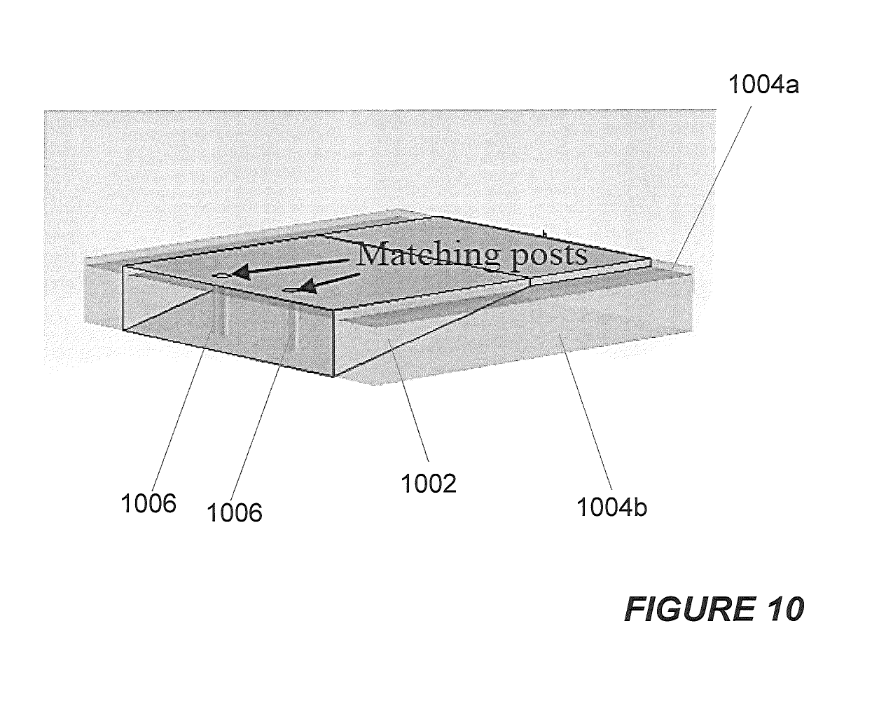

Referring to FIG. 10, a horn structure 1002 is shown. The horn structure 1002 may correspond to the horn 702 of FIG. 7 and/or the horn 402 of FIG. 4. In one embodiment, the horn 1002 may have dimensions of 3.6 mm×4.9 mm×0.8 mm. The horn 1002 may be embedded in a two-layer substrate. A first layer 1004a of the substrate may be Pyralux TK. A second layer 1004b of the substrate may be, for example, FR4 with a relative permittivity of 4.4. In some embodiments, the first layer 1004a may be 0.1 mm thick and the second layer 1004b may be 0.7 mm thick. The first layer 1004a may be used mainly for 60 GHz signal transmissions. One or more of the layers (e.g., the second layer 1004b) may be used for antenna purposes.

The horn structure 1002 may be associated with one or more matching posts 1006. The positions of the posts 1006 may be selected to obtain a particular antenna performance (e.g., optimum antenna performance).

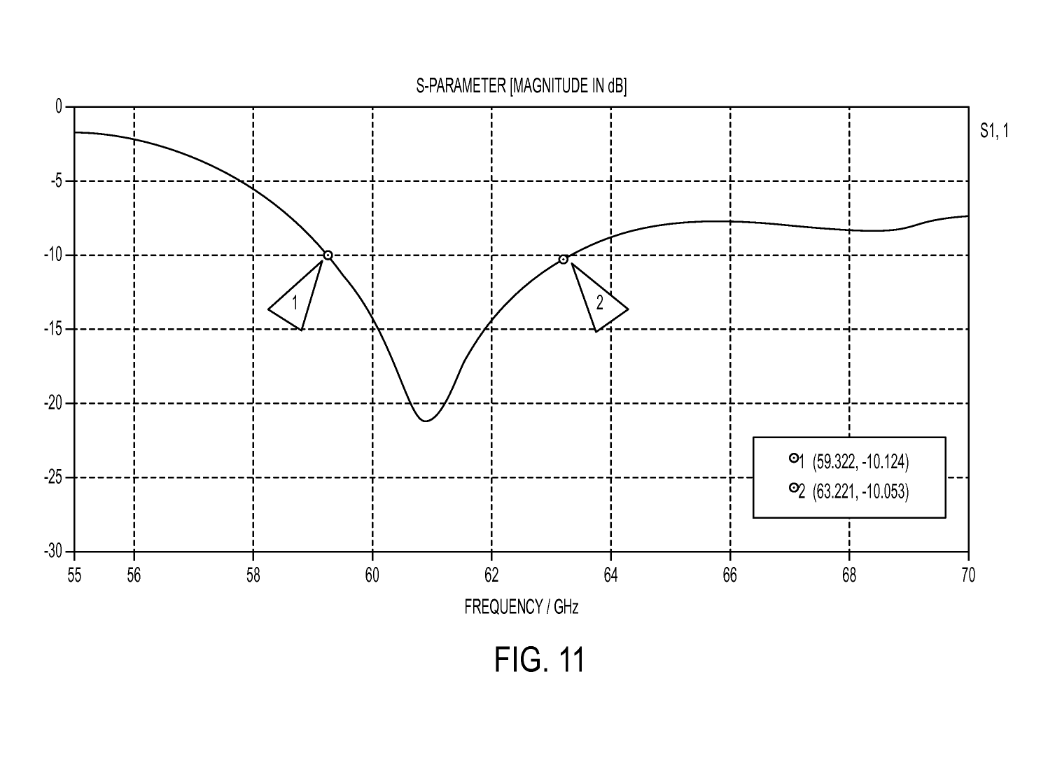

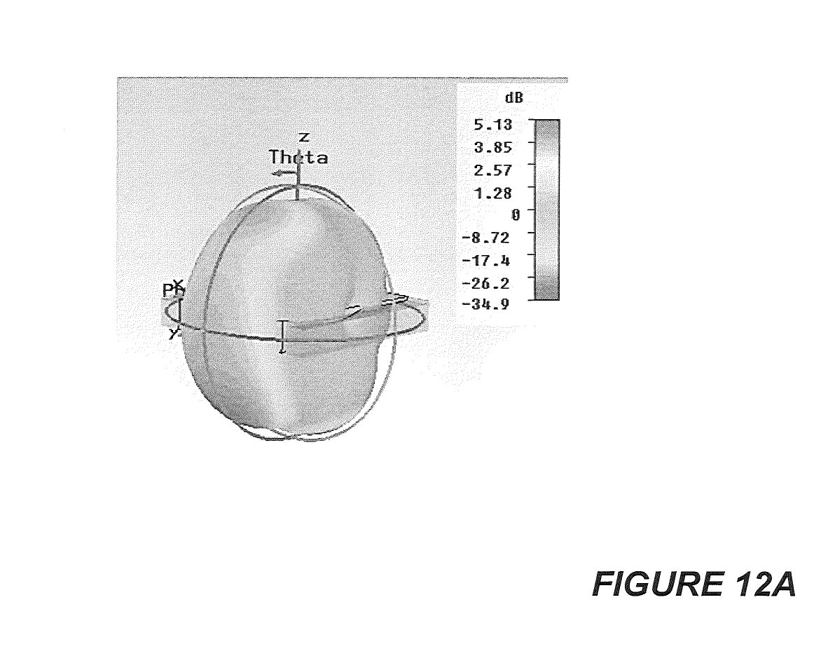

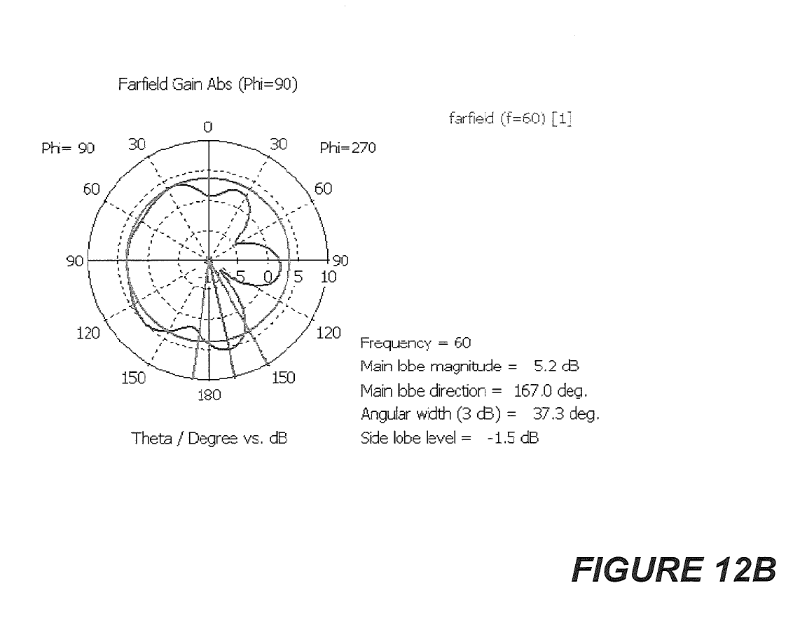

A reflection coefficient for the horn 1002 is shown in FIG. 11 and radiation patterns are shown in FIGS. 12A-12B. It is shown that a bandwidth of approximately 4 GHz and a maximum gain of approximately 5.13 dB may be obtained.

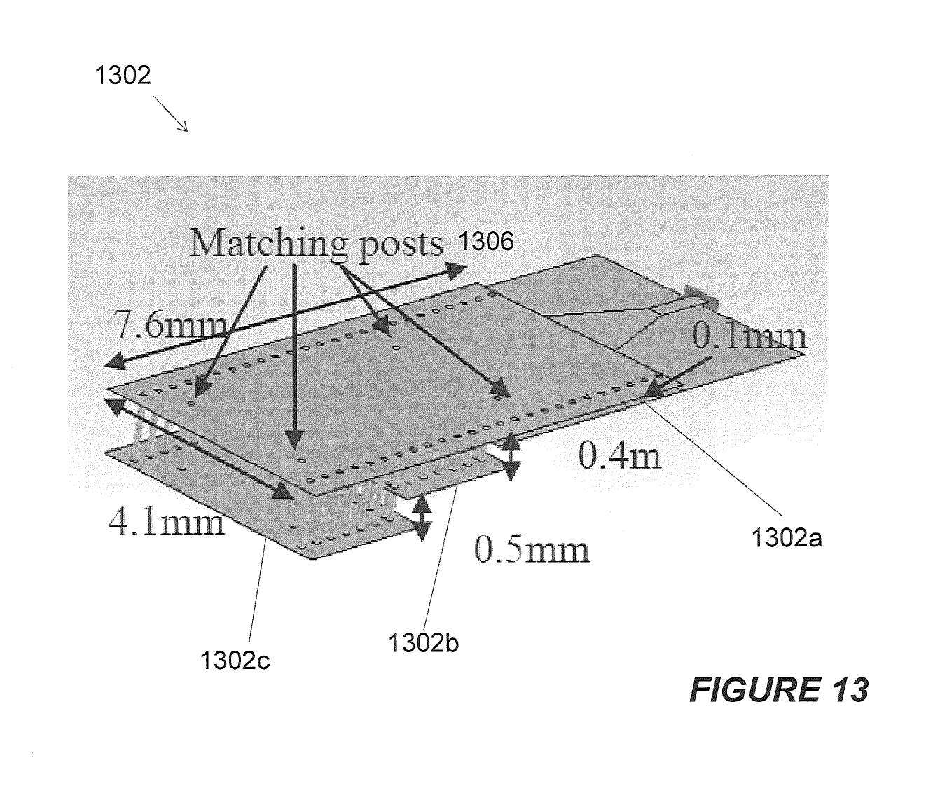

Referring to FIG. 13, a (SIW) horn antenna 1302 in free space (e.g., the antenna is “filled” with an air substrate) is shown. The air substrate may be imaginary and the structure shown in FIG. 13 may be used for purposes of simulation. As shown in FIG. 13, the dimensions of the whole SIW structure 1302 may be 4.1 mm×7.6 mm×1 mm. As shown in FIG. 13, the SIW structure 1302 may include three stair-cased SIWs 1302a-1302c. The top (0.1 mm) SIW 1302a may be used for, e.g., 60 GHz signal transmission. The signal may be excited by a microstrip line and then go to the top SIW. The middle (0.4 mm) SIW 1302b and the bottom (0.5 mm) SIW 1302c may be used for antenna purposes.

As shown in FIG. 13, matching posts 1306 may be placed to reduce reflections and optimize performance.

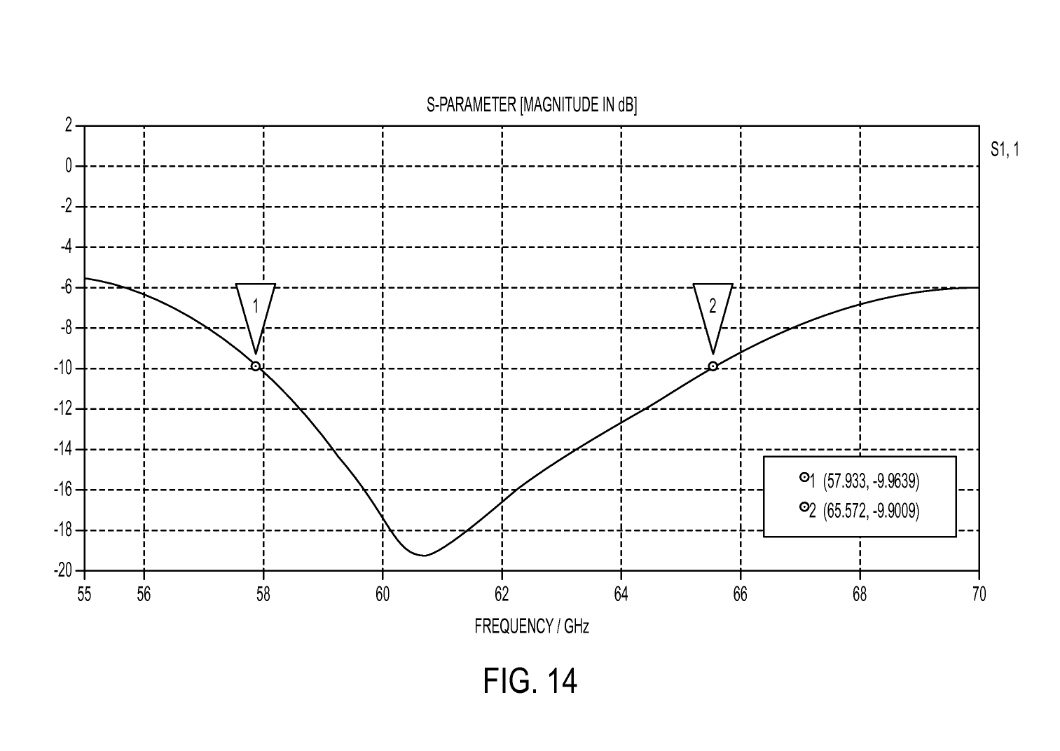

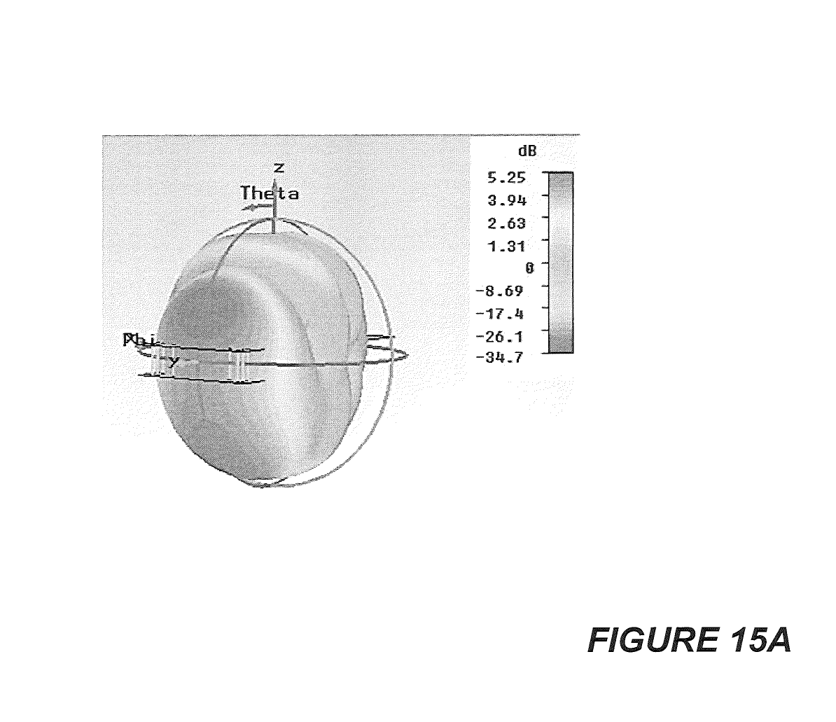

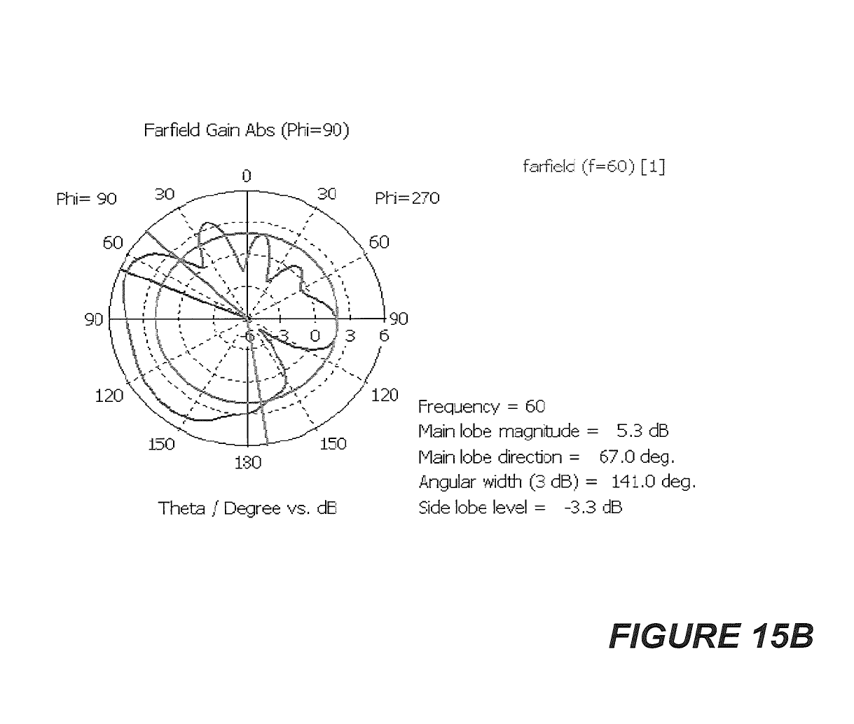

A reflection coefficient for the horn 1302 is shown in FIG. 14 and radiation patterns are shown in FIGS. 15A-15B. It is shown that a bandwidth of approximately 8 GHz and a maximum gain of approximately 5.25 dB may be obtained.

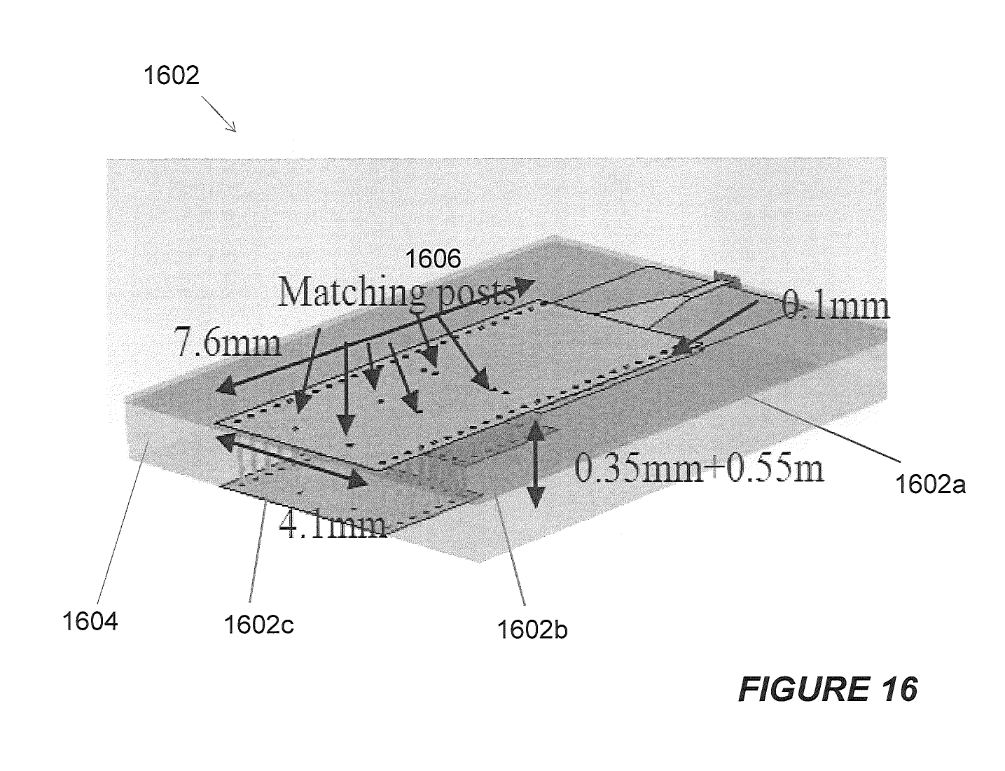

Referring to FIG. 16, a (SIW) horn antenna 1602 embedded in a substrate 1604 is shown. The substrate 1604 may be a uniform substrate. The dimensions of the whole SIW antenna structure 1602 may be 4.1 mm×7.6 mm×1 mm. The SIW antenna structure 1602 may include three stair-cased SIWs 1602a-1602c. The top (0.1 mm) SIW 1602a may be used for, e.g., 60 GHz signal transmission. The middle (0.35 mm) SIW 1602b and the bottom (0.55 mm) SIW 1602c may be used for antenna purposes.

As shown in FIG. 16, matching posts 1606 may be placed to reduce reflections and optimize horn performance.

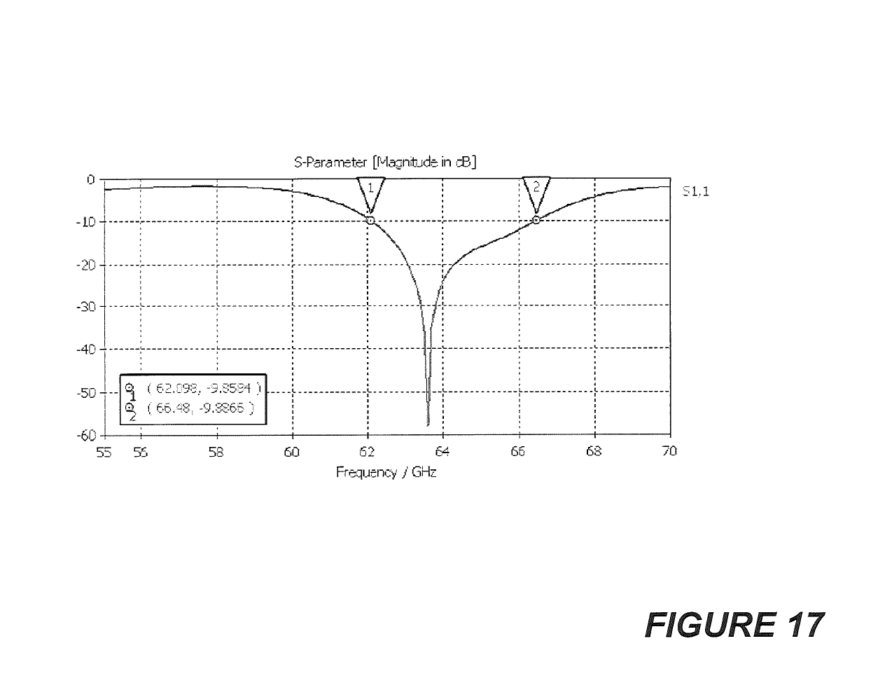

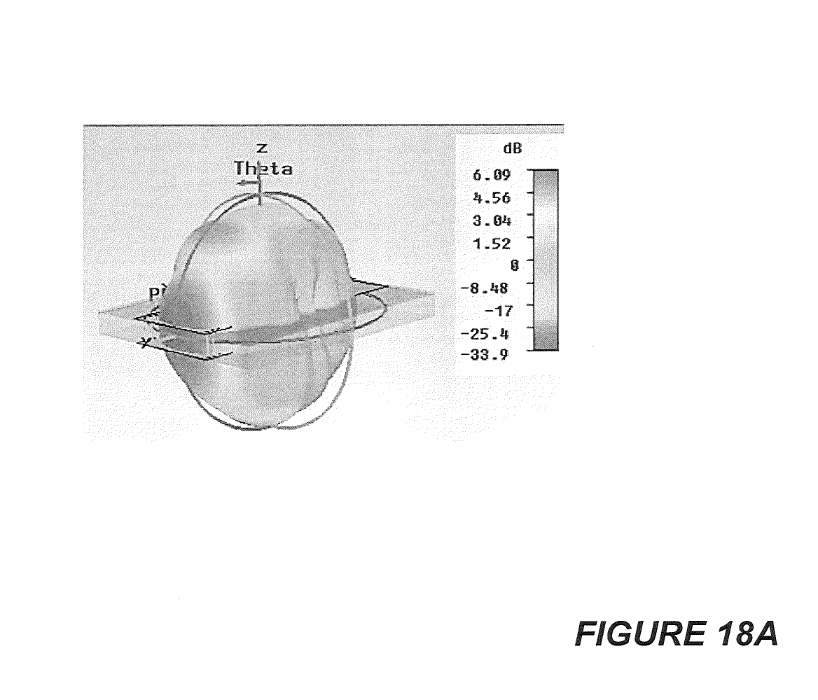

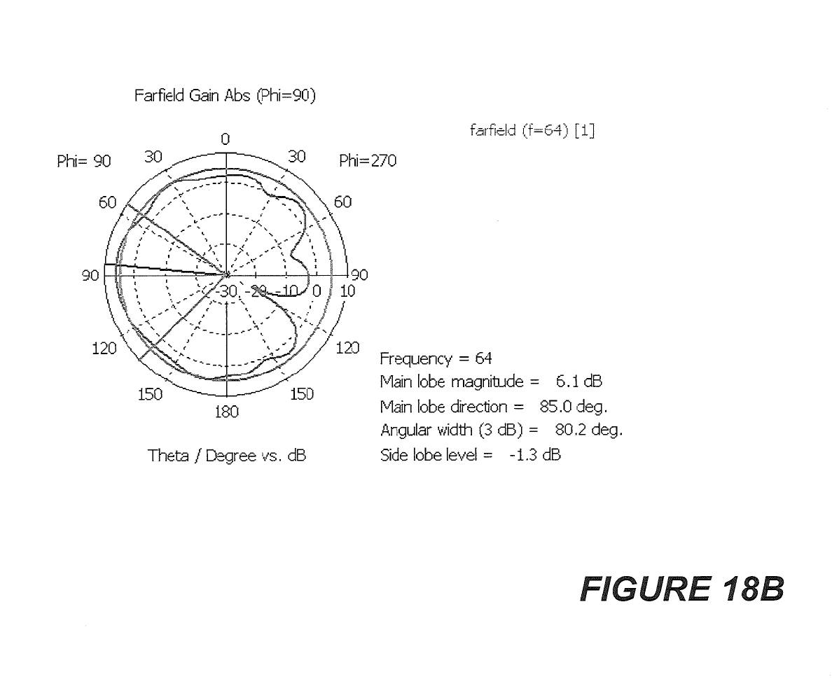

A reflection coefficient for the horn 1602 is shown in FIG. 17 and radiation patterns are shown in FIGS. 18A-18B. It is shown that a bandwidth of approximately 4.4 GHz and a maximum gain of approximately 6.09 dB may be obtained.

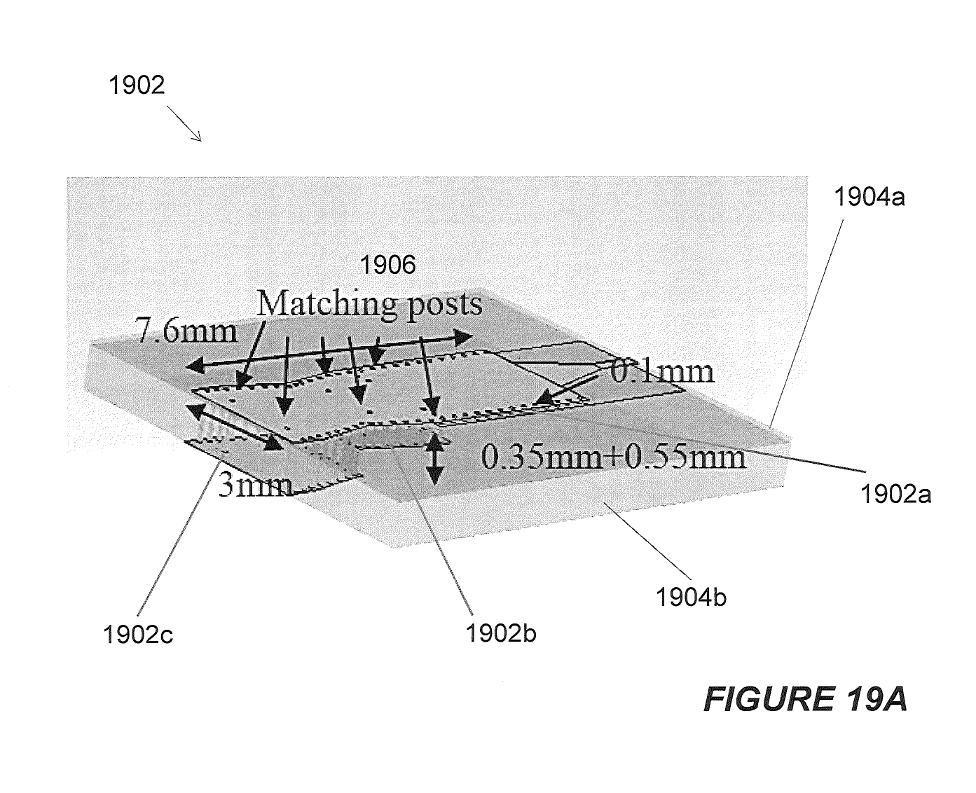

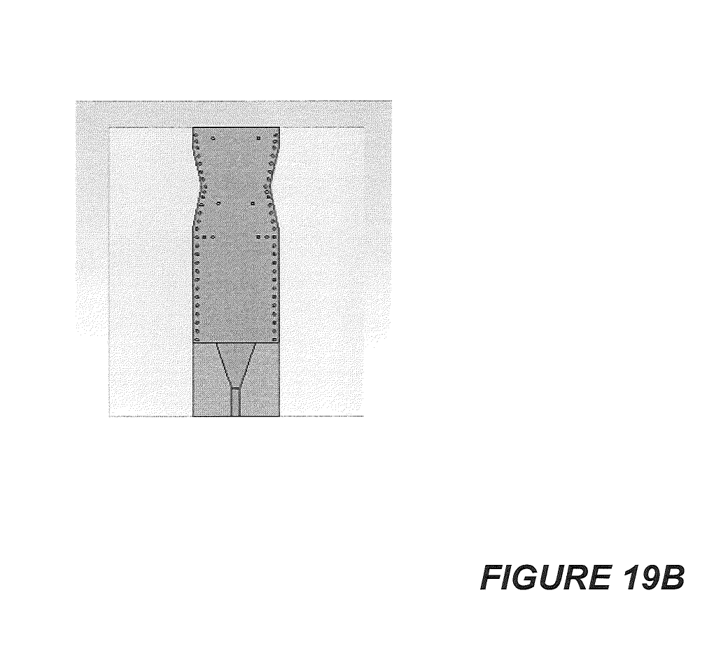

Referring to FIGS. 19A-19B (collectively referred to as FIG. 19), a substrate integrated waveguide (SIW) horn antenna 1902 embedded in a substrate 1904 is shown. The substrate 1904 may be a two-layered substrate, 1904a and 1904b. The dimensions of the whole SIW antenna structure 1902 may be 3 mm×7.6 mm×1 mm. The SIW antenna structure 1602 may include three stair-cased SIWs 1902a-1902c. The top (0.1 mm) SIW 1902a may be used for, e.g., 60 GHz signal transmission and may be made of Pyralux TK. The middle (0.35 mm) SIW 1902b and the bottom (0.55 mm) SIW 1902c may be used for antenna purposes and may be made of FR4.

As shown in FIG. 19, matching posts 1906 may be placed to reduce reflections and optimize performance. At the stair boundaries, the shape of the SIWs 1902a-1902c may be adjusted such that antenna performance is maximized.

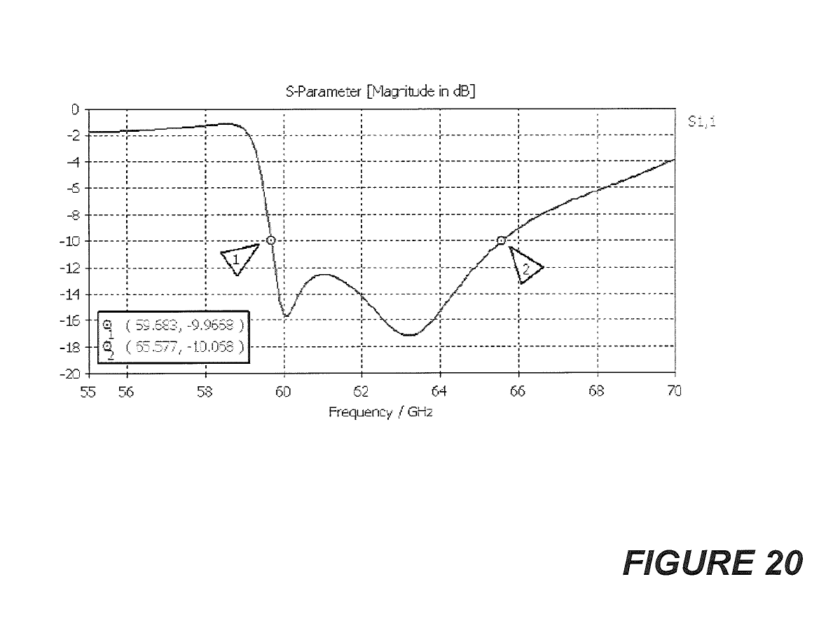

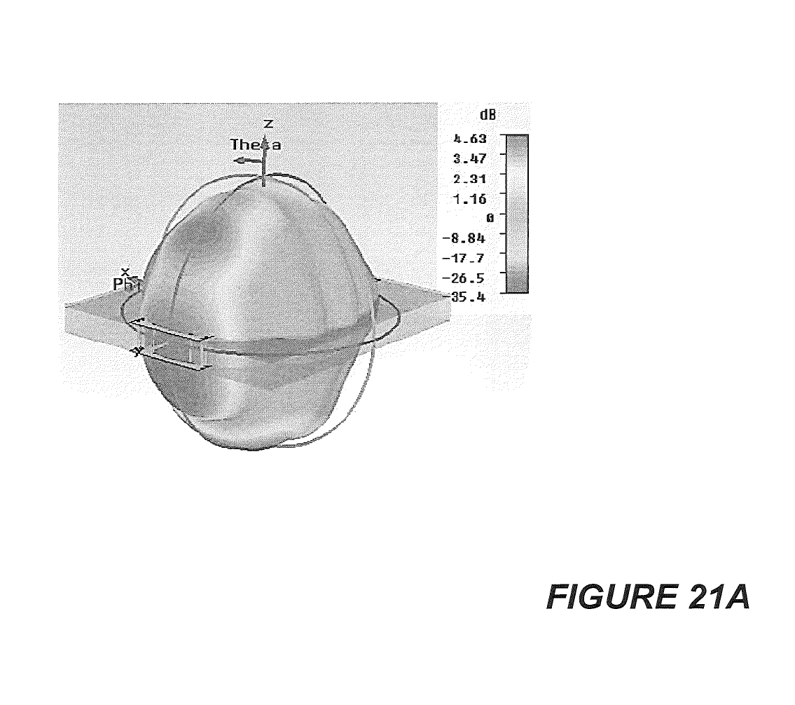

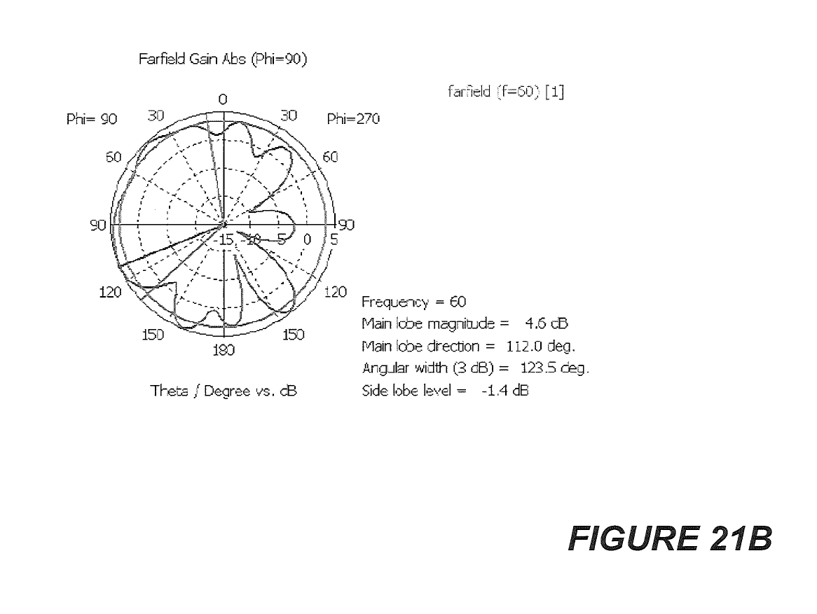

A reflection coefficient for the horn 1902 is shown in FIG. 20 and radiation patterns are shown in FIGS. 21A-21B. It is shown that a bandwidth of approximately 6 GHz and a maximum gain of approximately 4.6 dB may be obtained.

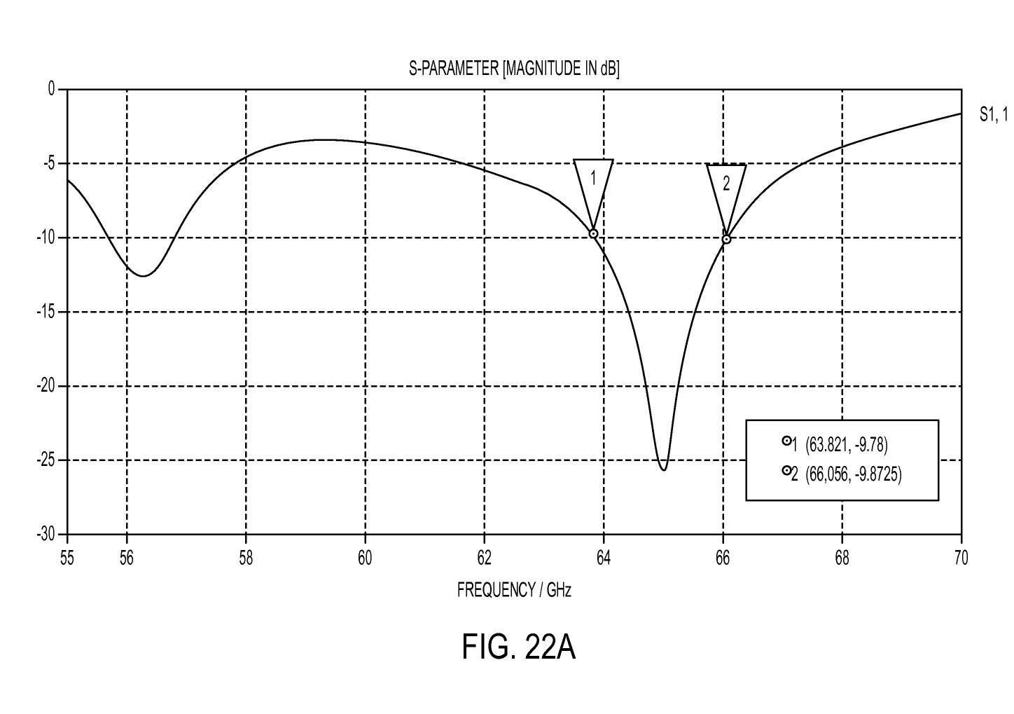

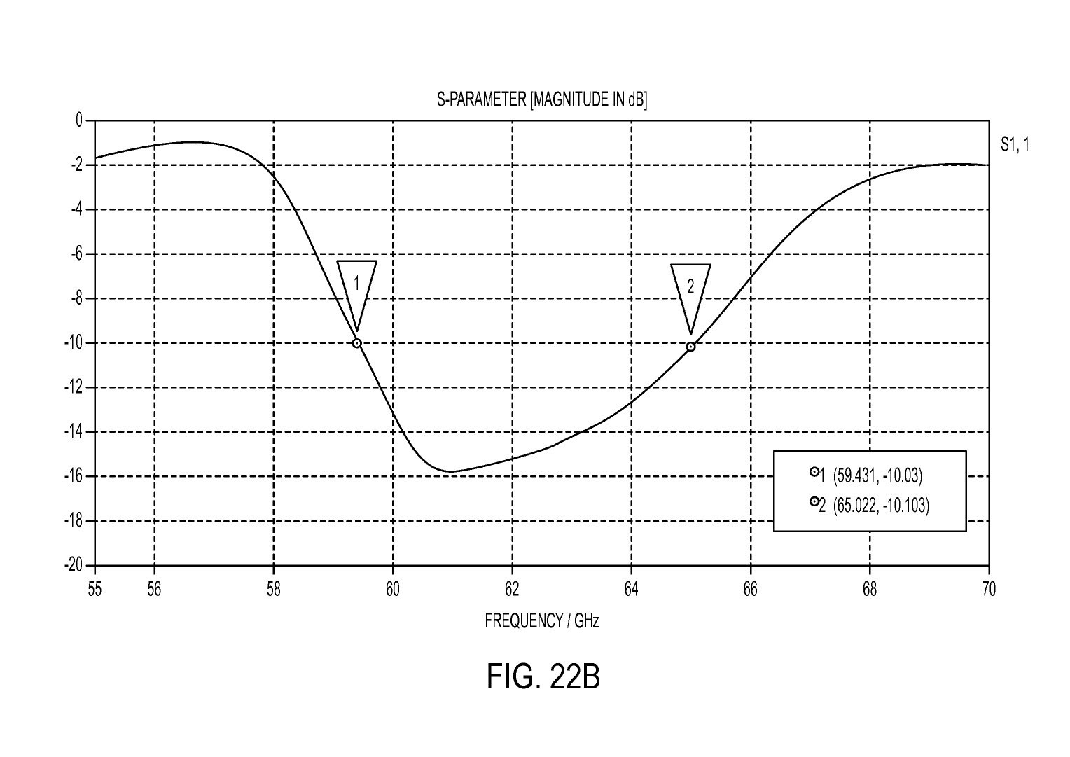

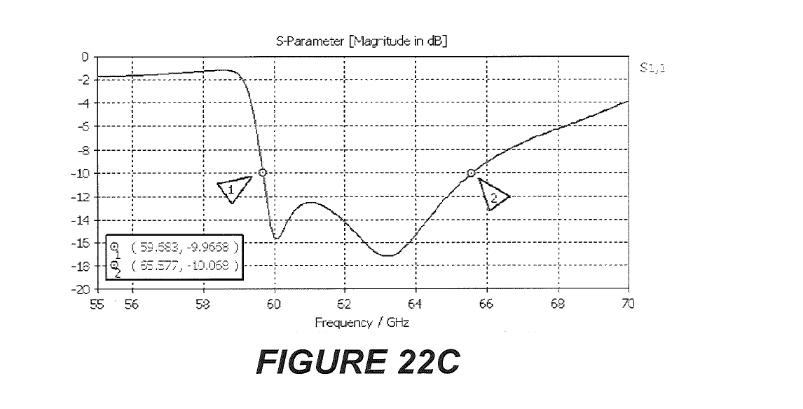

A description of tuning/matching is now provided in connection with three illustrated cases: a first case (corresponding to FIGS. 22A, 23A, and 24A) where a SIW antenna does not include matching posts or shape adjustment, a second case (corresponding to FIGS. 22B, 23B, and 24B) where a SIW antenna includes matching posts, and a third case (corresponding to FIGS. 22C, 23C, and 24C) where a SIW antenna includes both matching posts and shape adjustments.

As shown in FIGS. 22A-22C, by placing matching posts, the bandwidth may be considerably broadened.

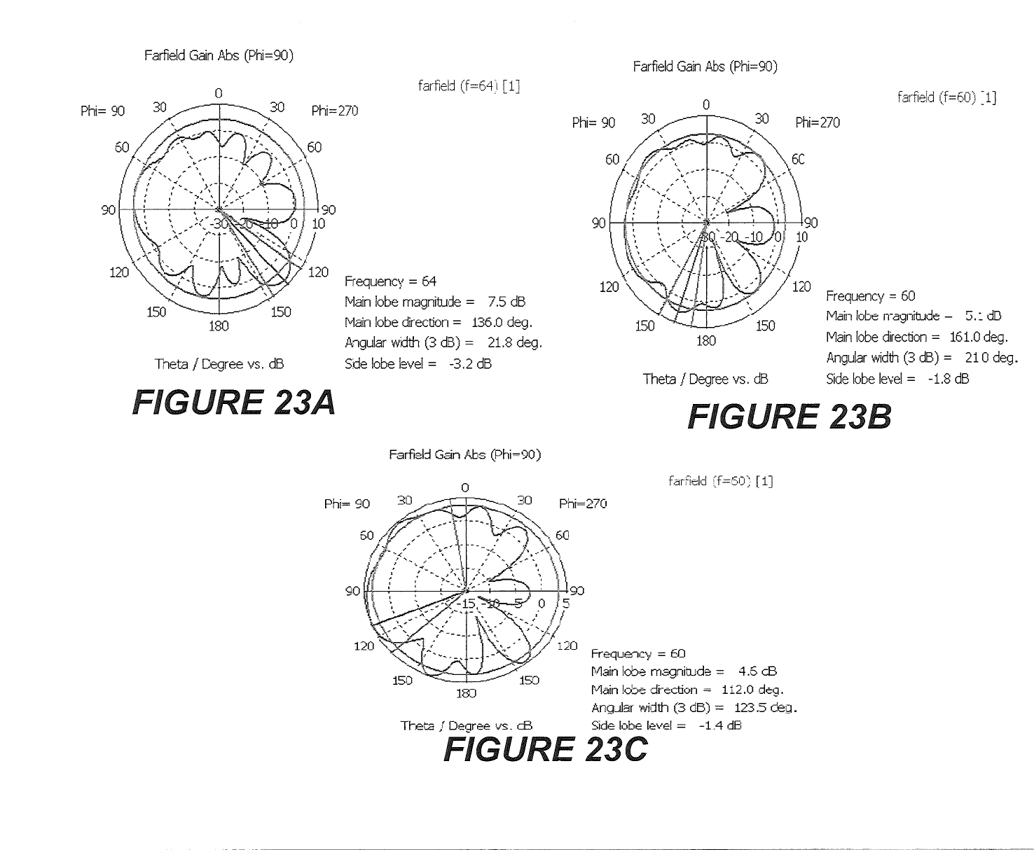

As shown in FIGS. 23A-23C, the radiation pattern may be improved by placing matching posts and performing shape adjustment, e.g., backward/downward radiations may be minimized to achieve a better forward radiation.

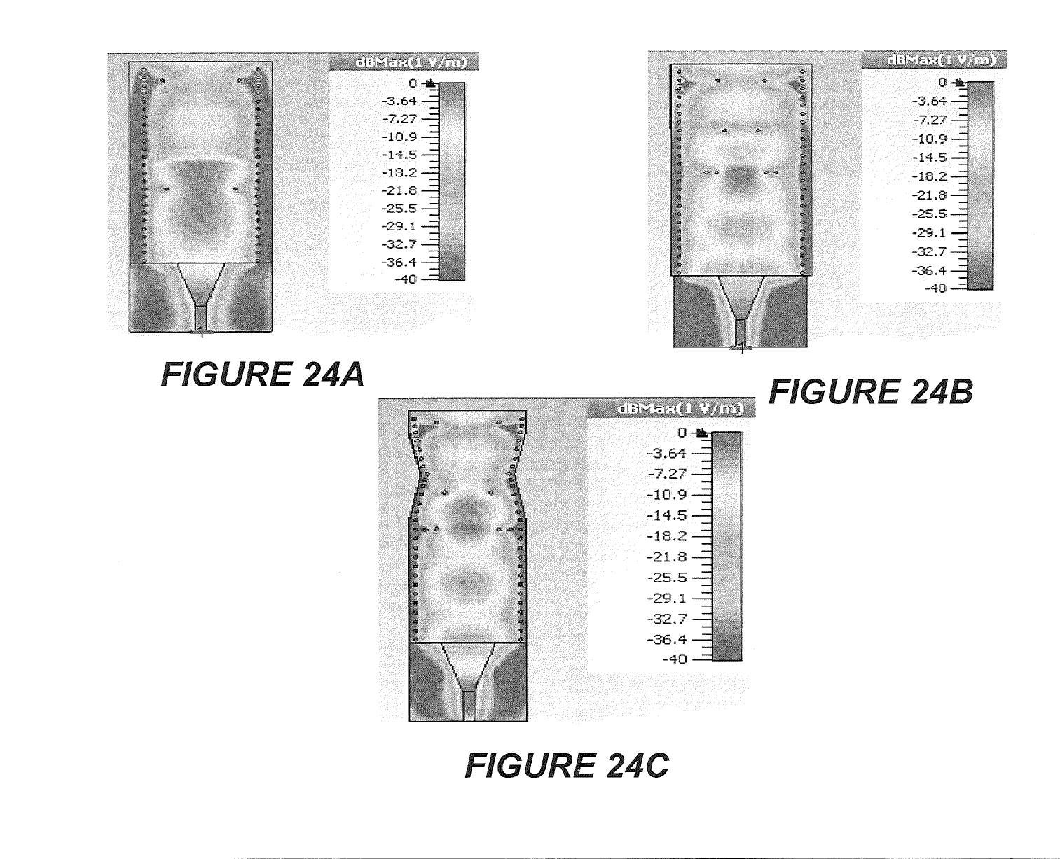

As shown in FIG. 24A, there may be some wave reflection at a stair boundary. The wave reflection may be removed by placing the matching posts nearby (e.g., FIG. 24B). By further shape adjustment (e.g., FIG. 24C), the Transverse electric (TE10) mode may be better preserved and unwanted modes that are excited at the stair boundaries may be removed.

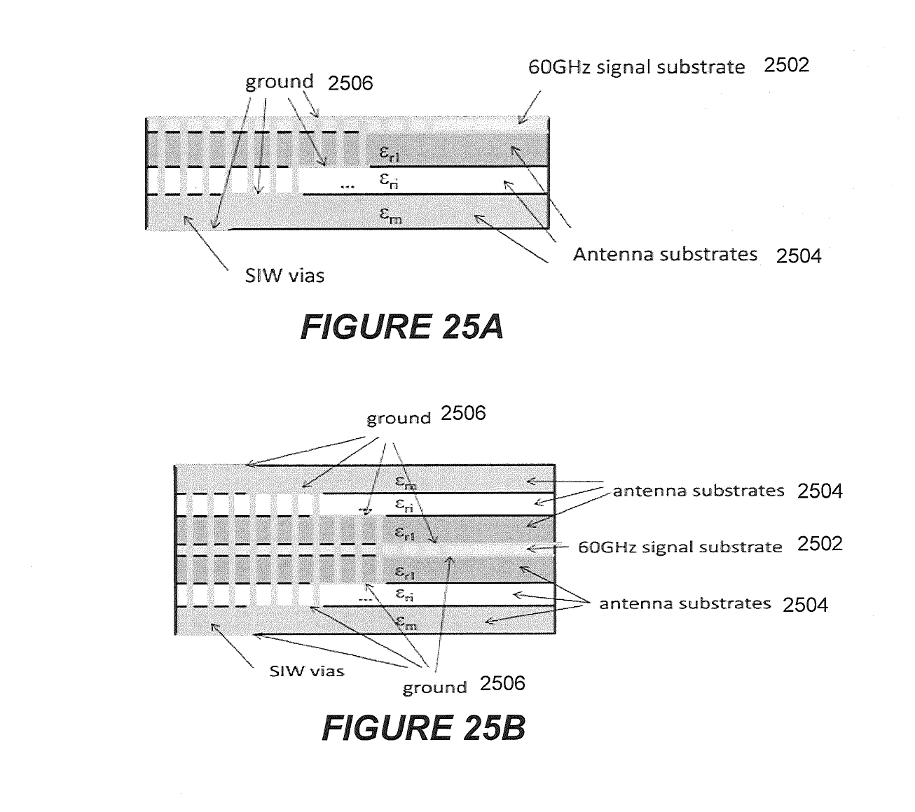

In some embodiments, a SIW antenna structure may be of the form shown in FIGS. 25A-25B. As shown in FIGS. 25A-25B, a 60 GHz signal might only go through a thin layer 2502. This can be implemented by using a microstrip line feeding structure. Then, substrates 2504 with different properties can be added to increase the volume of the antenna, i.e., potentially the aperture too. One or more ground layers 2506 may be used to further improve or enhance signal quality.

The horn structures shown in FIGS. 25A-25B may facilitate an increase in gain on the order of 2-5 dB for a given antenna volume relative to conventional antenna structures. For example, the increase in gain may be relative to structures that could be conventionally made in a substrate with the same area using, e.g., a patch antenna.

In some embodiments, a SIW aperture can be extended in both the vertical and horizontal direction, given that the structure can be flared in both E and H planes. This can further increase the gain of an antenna. For example, the gain of the horn may be expressed as:

$$G = \frac{4 π {A}_{eff}}{{λ}^{2}} = \frac{4 π {A}_{phys} {e}_{a}}{{λ}^{2}}$$

where A_{phys} may represent the physical aperture area and eₐ may represent a ratio defining the effective aperture area to the physical area.

As described above, integrating interconnect/transition technology in a 60 GHz (i.e., WiGig/IEEE 802.11 ad) system may be challenging. Embodiments of this disclosure describe the use of an efficient, low loss, and compact transmission line transition that can connect SIW devices to a chip circuit.

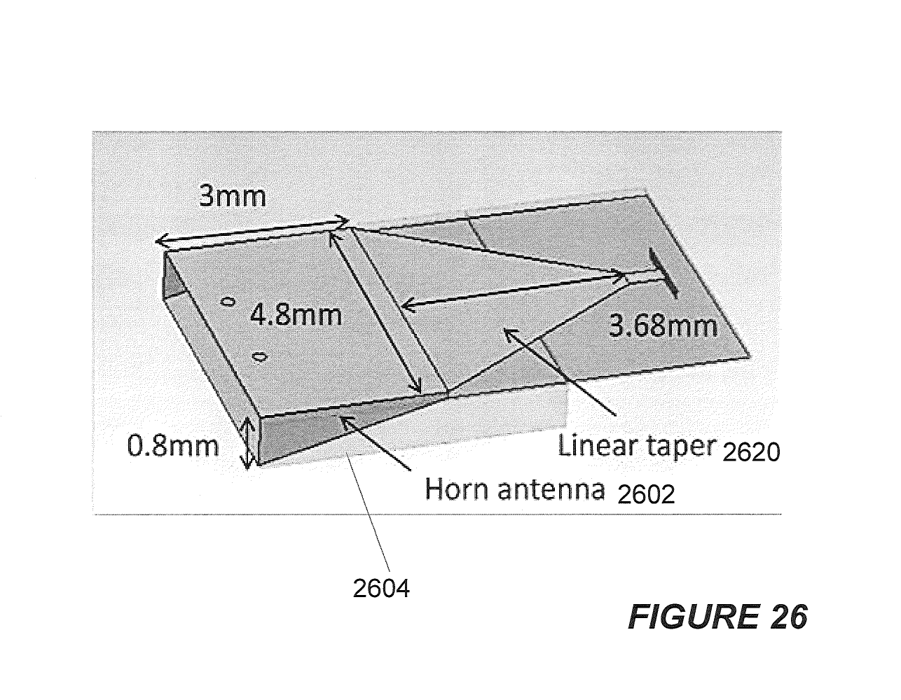

Referring to FIG. 26, a horn antenna 2602 is shown as embedded in a substrate 2604. The substrate 2604 may be Pyralux TK. A microstrip-to-horn antenna transition may be implemented using a linear taper 2620. As shown, the length of the taper 2620 may be 3.68 mm. The dimension of the horn antenna 2602 may be 4.8 mm×3 mm×0.8 mm.

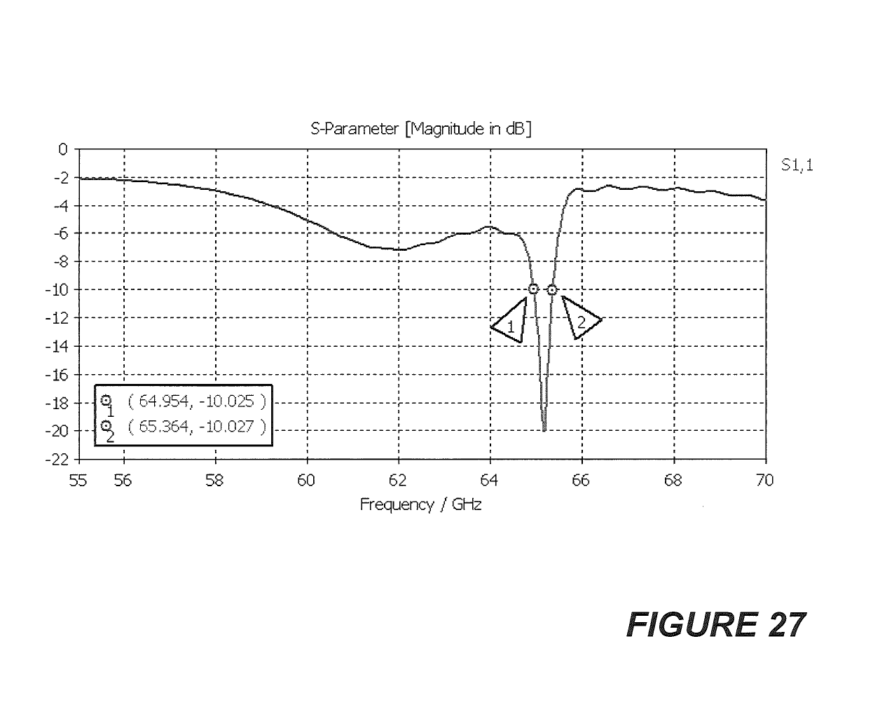

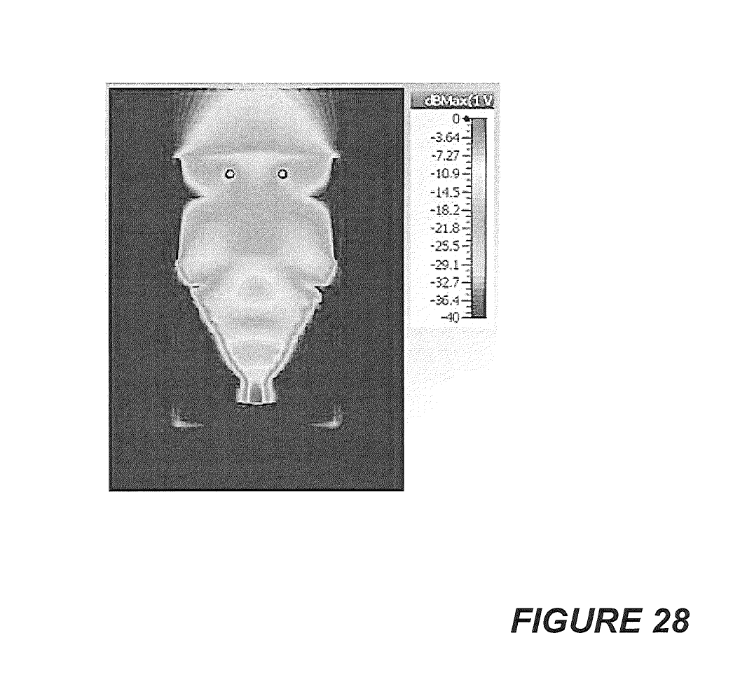

A reflection coefficient for the transition 2620 and horn 2602 is shown in FIG. 27 and an E field distribution (magnitude) at resonance is shown in FIG. 28.

The linear transition/taper 2620 may provide a narrow bandwidth and may generate some unwanted modes in the horn 2602.

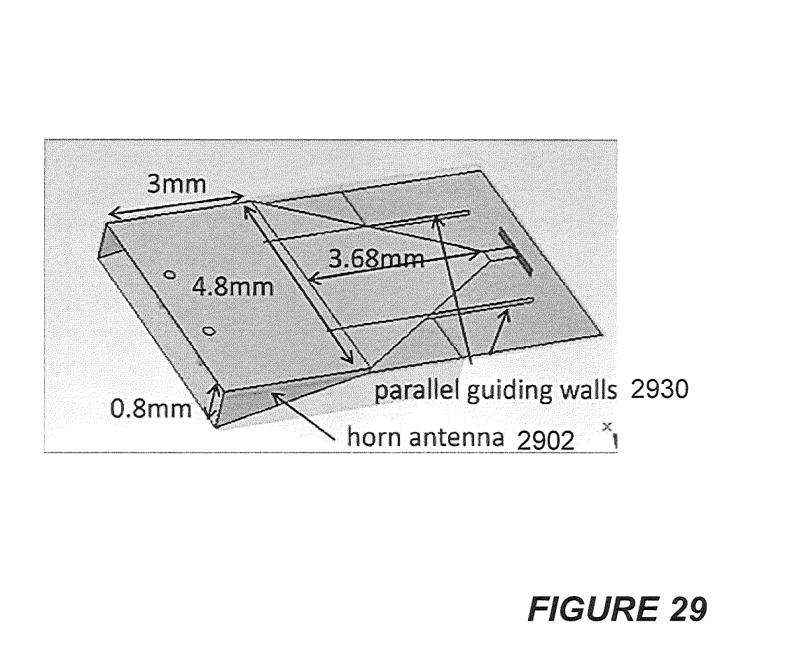

FIG. 29 shows a horn antenna 2902 with parallel guiding walls 2930 in the transition having been included. The horn antenna 2902 may correspond to the horn antenna 2602.

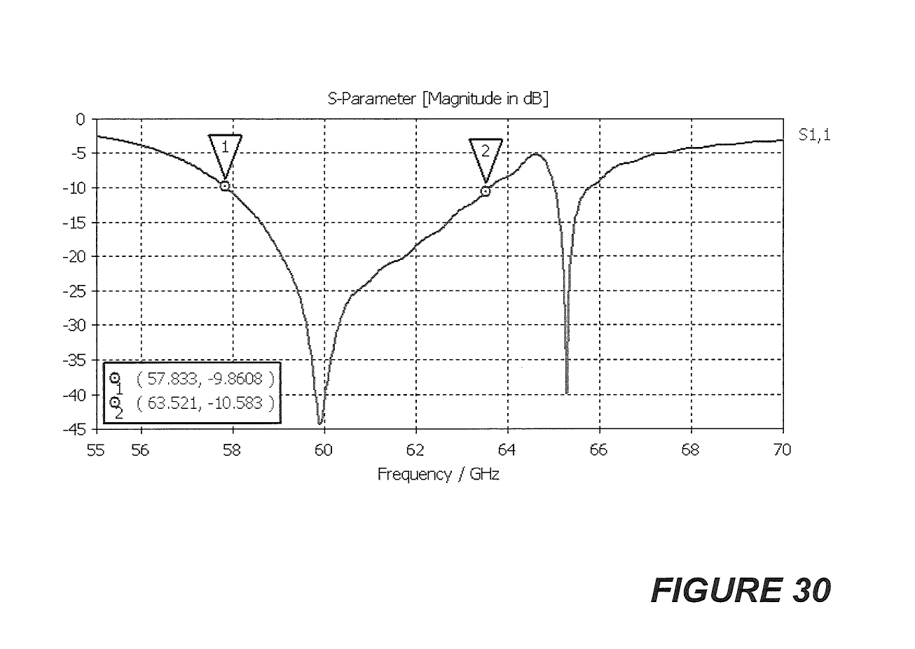

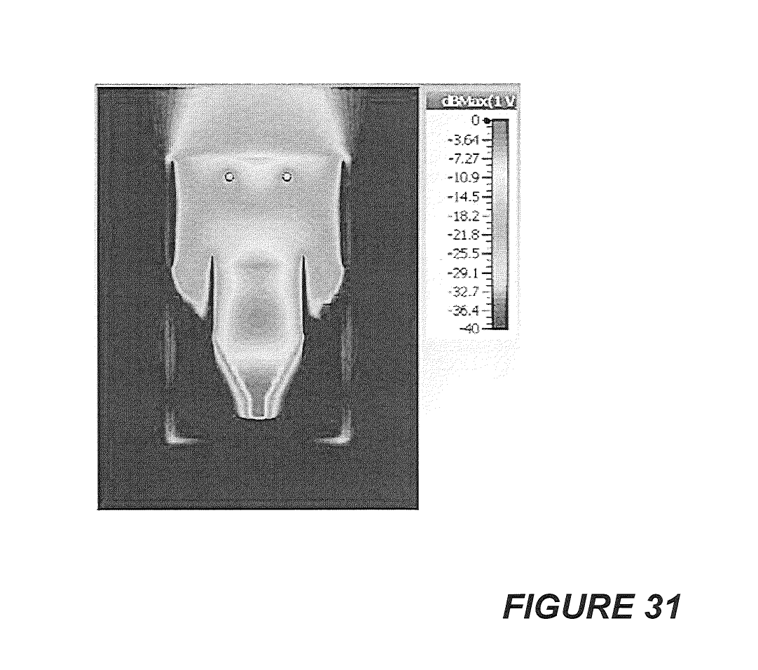

A reflection coefficient for the transition with guiding walls 2930 and horn 2902 is shown in FIG. 30 and an E field distribution (magnitude) at resonance is shown in FIG. 31. Relative to the performance of the horn 2602, the horn 2902 might not include to the same extent the unwanted modes as a result of the addition of the guiding walls 2930. A TE₁₀ mode may be better preserved using the structure of FIG. 29 and a 5.7 GHz bandwidth may be obtained.

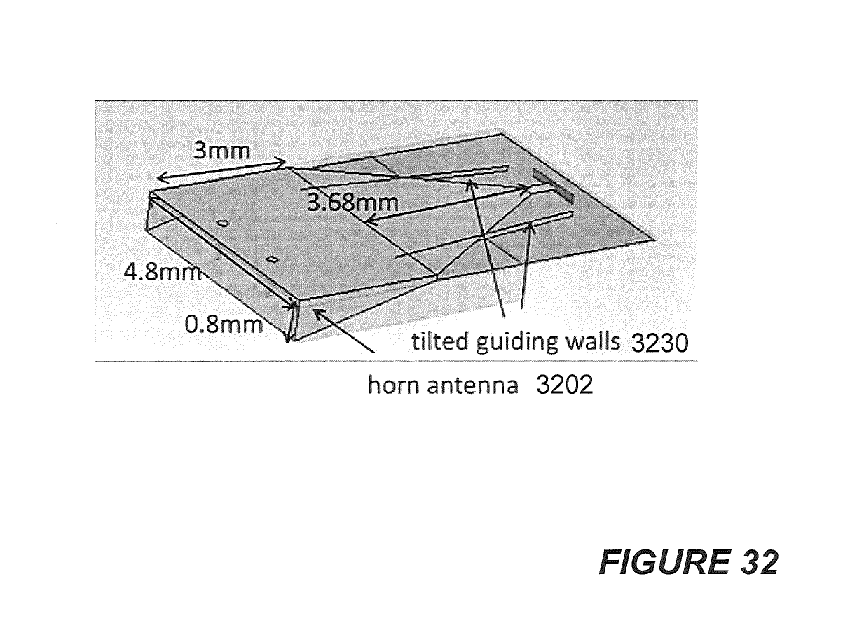

FIG. 32 shows a horn antenna 3202 with parallel guiding walls 3230 in the transition having been included. The horn antenna 3202 may correspond to, e.g., the horn antenna 2602 and/or the horn antenna 2902. The guiding walls 3230 may correspond to the guiding walls 2930, but may be tilted or bent relative to the guiding walls 2930.

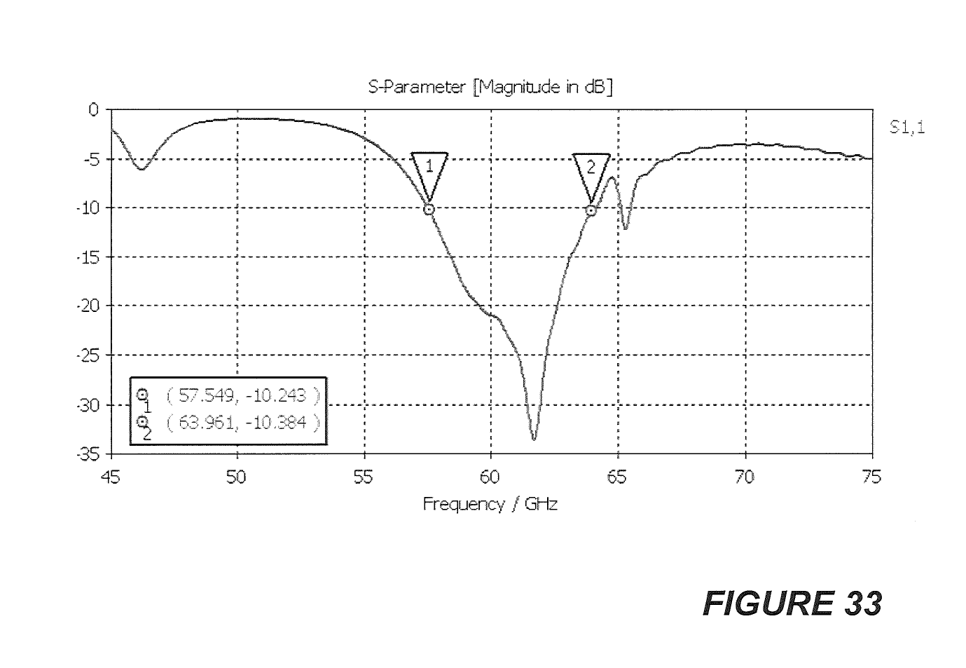

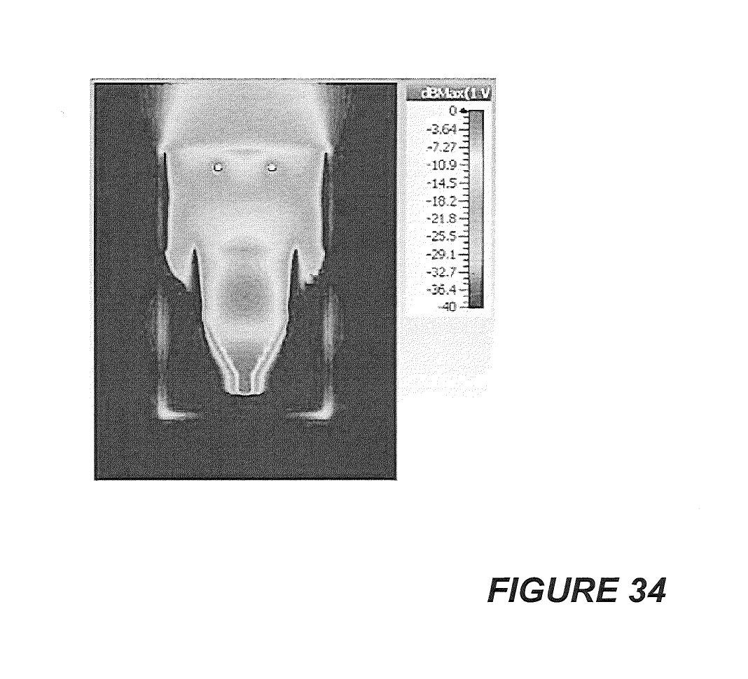

A reflection coefficient for the transition with guiding walls 3230 and horn 3202 is shown in FIG. 33 and an E field distribution (magnitude) at resonance is shown in FIG. 34. Relative to the performance of the horns 2602 and 2902, the horn 3202 might not include to the same extent the unwanted modes as a result of the addition and tilting of the guiding post walls 3230, and an improved bandwidth of 6.4 GHz may be obtained.

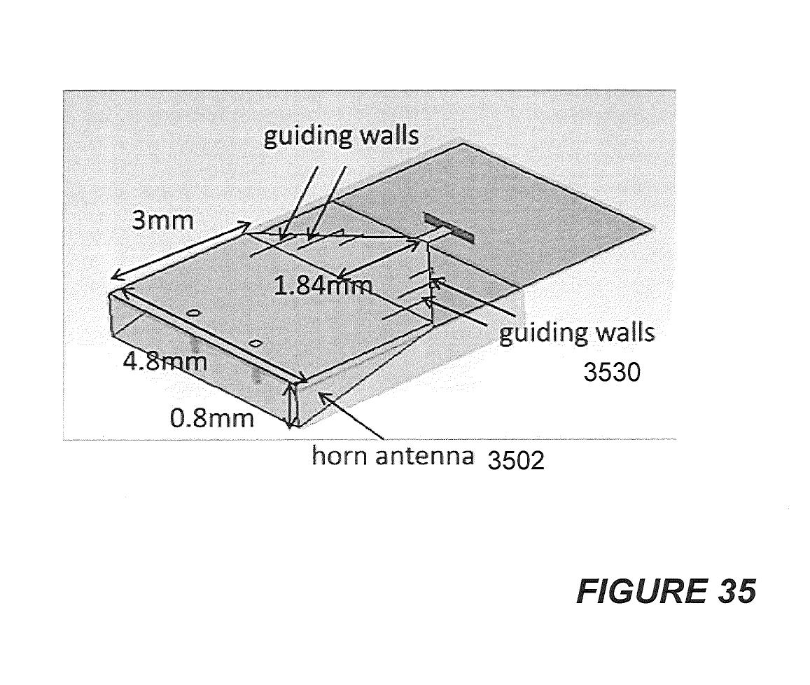

FIG. 35 illustrates a horn antenna 3502. The horn antenna 3502 may correspond to one or more of the horn antennas 2602, 2902, and 3202, but might include a microstrip-to-horn antenna transition of 1.84 mm, which is less than the corresponding microstrip-to-horn antenna transition for the horn antennas 2602, 2902, and 3202 shown in FIGS. 26, 29, and 32, respectively.

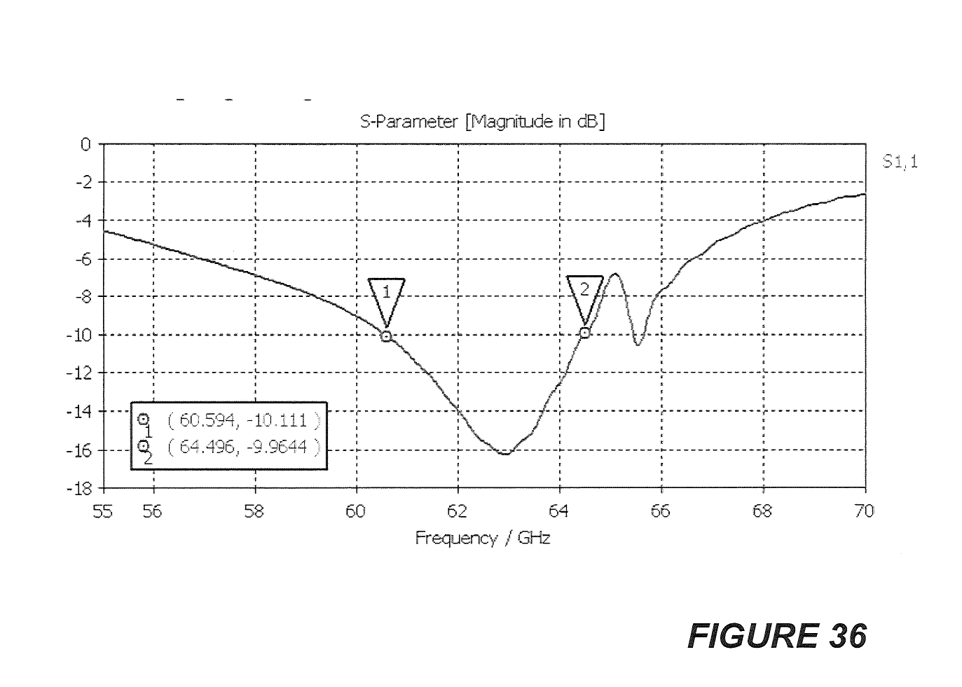

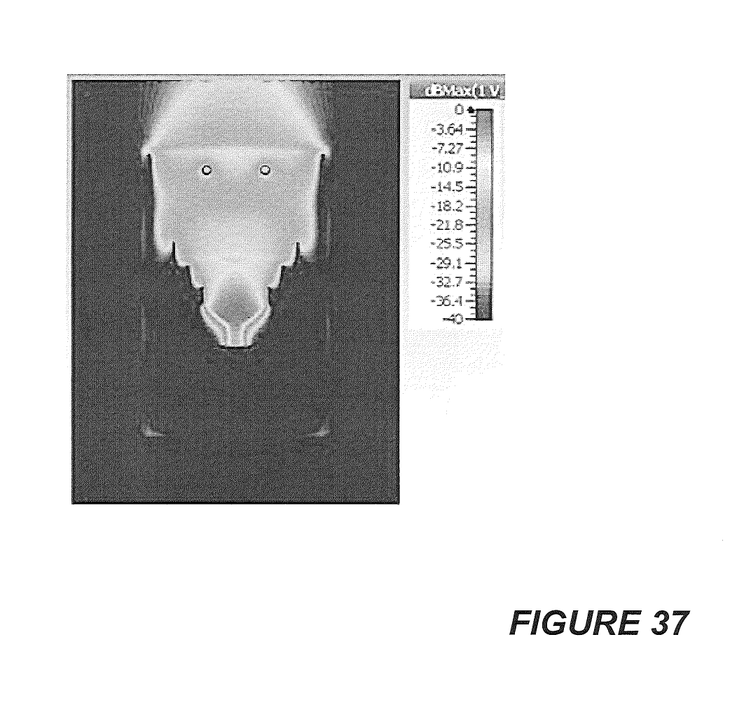

The horn antenna 3502 may be associated with multiple guiding walls 3530 to obtain reasonable S11 performance/characteristics. A reflection coefficient for the transition with multiple guiding walls 3530 and horn 3502 is shown in FIG. 36 and an E field distribution is shown in FIG. 37. As shown in FIG. 37, some unwanted modes may be excited in the waveguide antenna of FIG. 35; a bandwidth of 4 GHz may be obtained.

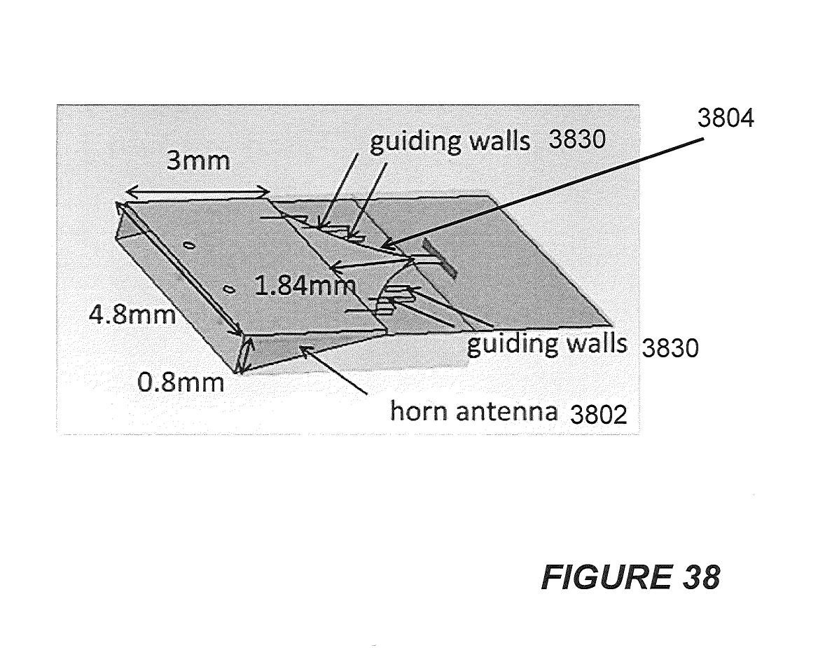

FIG. 38 illustrates a horn antenna 3802. The horn antenna 3802 may correspond to one or more of the horn antennas 2602, 2902, 3202, and 3502 but might include a microstrip-to-horn antenna transition using a curved taper 3804.

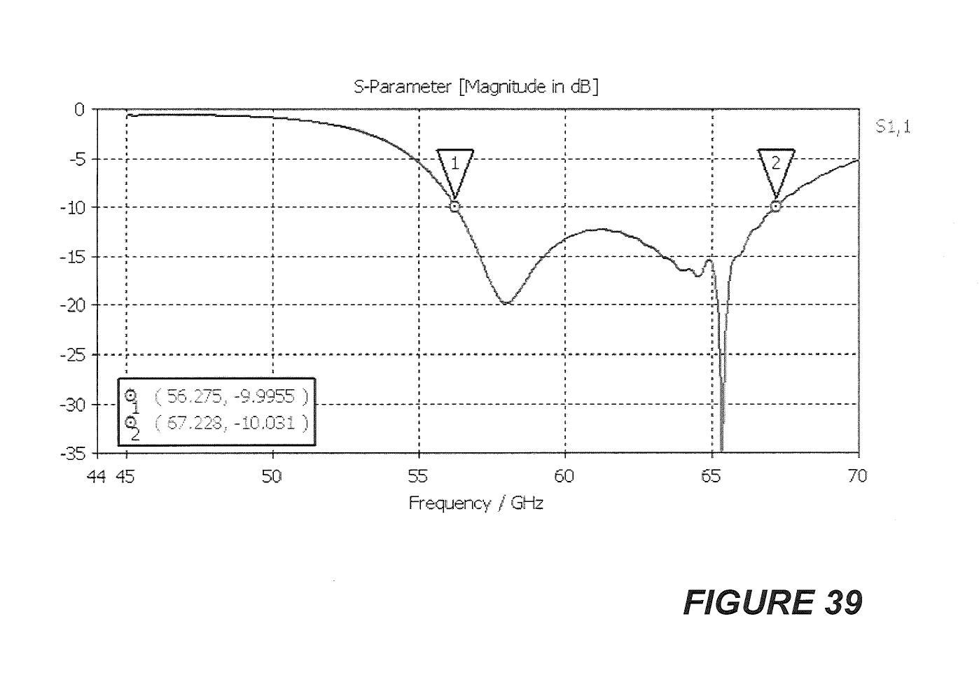

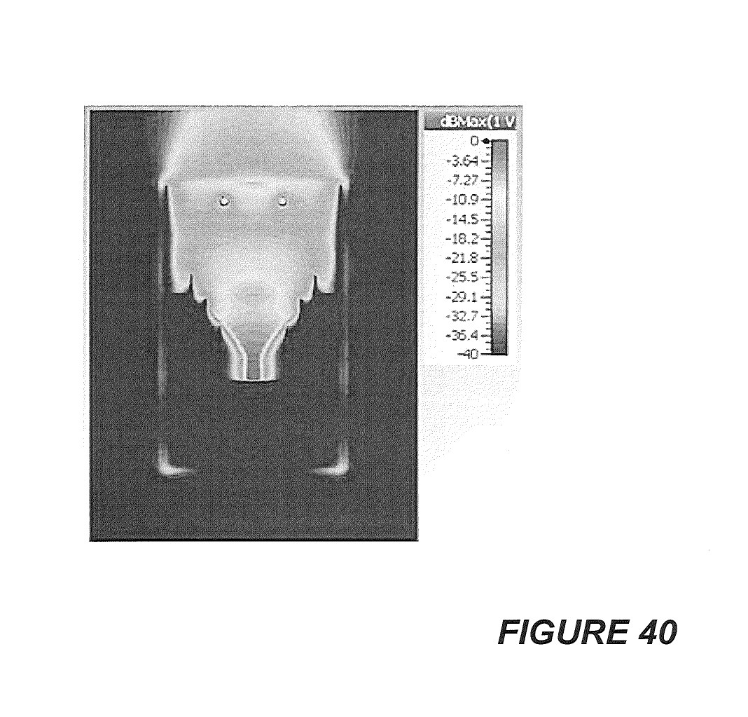

The horn antenna 3802 may be associated with multiple guiding walls 3830. A reflection coefficient for the transition with multiple guiding walls 3830 and curved taper (insert reference for curved taper) and horn 3802 is shown in FIG. 39 and an E field distribution is shown in FIG. 40. As shown in FIG. 40, with the curved taper transition, the wave may be better guided in the transition to maintain its form. Consequently, the unwanted modes in the waveguide antenna may disappear and the TE₁₀ may be better preserved. The resulting reflection coefficient (S11) may correspond to almost 11 GHz. An improvement in bandwidth may also be realized using the horn antenna 3802.

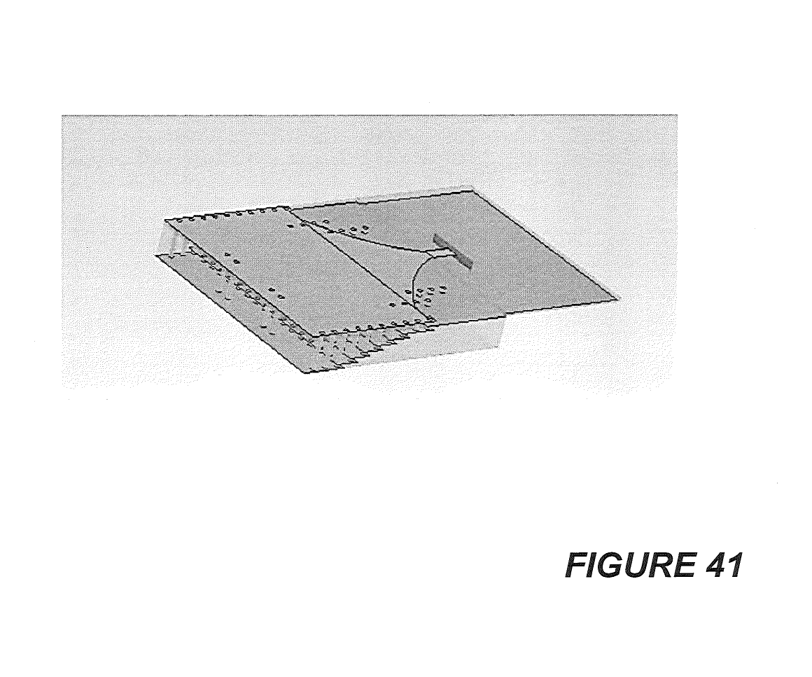

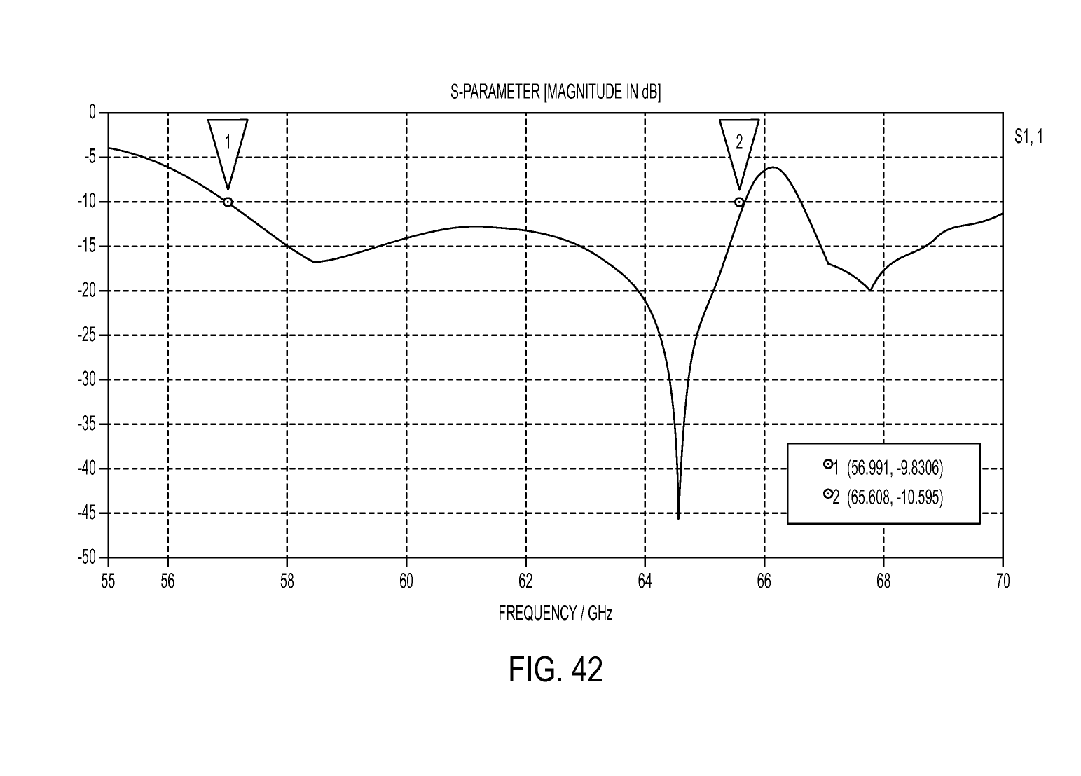

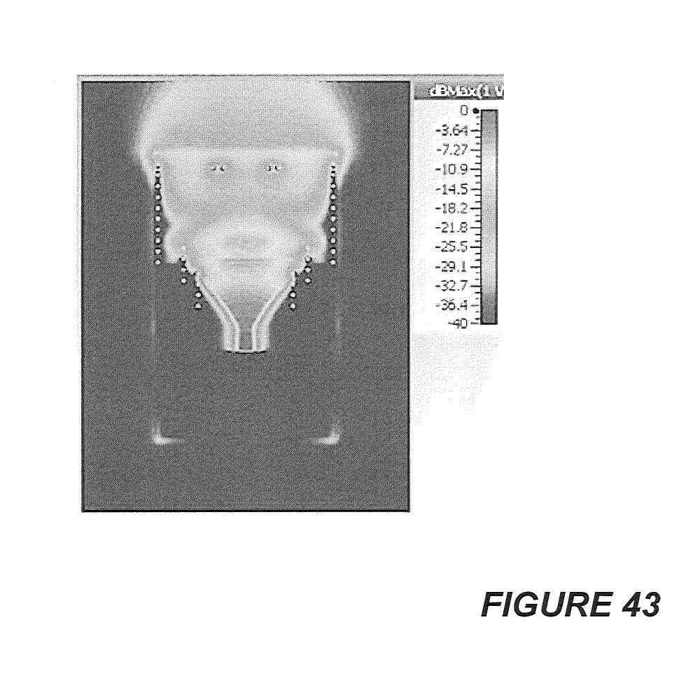

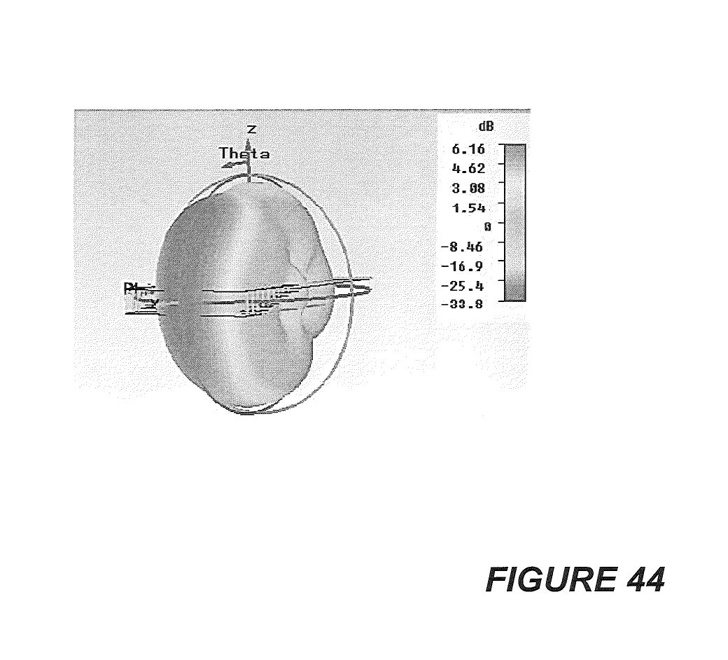

FIG. 41 shows a SIW version of the transition and antenna structure for the ideal horn and transition of FIG. 38. A reflection coefficient for the horn of FIG. 41 is shown in FIG. 42, an E field distribution is shown in FIG. 43; and a 3D far field radiation pattern is shown in FIG. 44. The horn antenna of FIG. 41 may be associated with a bandwidth of approximately 8.7 GHz and a gain of approximately 6.16 dB.

In some embodiments, one or more of the structures described above may adhere to a via diameter of 0.1 mm, a via to via spacing of 0.2 mm, and a via to metal edge of 0.1 mm.

As described above, in some embodiments one or more SIW walls may be used in a transition to guide a wave more efficiently. By tuning the angle, position, and number of SIW walls, the transition may gain a much broader bandwidth. Unwanted modes in the connected horn antenna may be reduced or eliminated. The transition may be made in a curved manner or fashion. This can lead to a much more compact volume, e.g., half the original length but with improved performance (e.g., a bandwidth increase of approximately 40% may be realized compared to a linear taper of twice the length).

In some embodiments, one or more of the structures described herein may be implemented in one or more devices. For example, a first structure similar to that shown in FIG. 26 may be implemented in a first device (e.g., a mobile device) and a second structure similar to that shown in FIG. 26 may be implemented in a second device (e.g., a docking station).

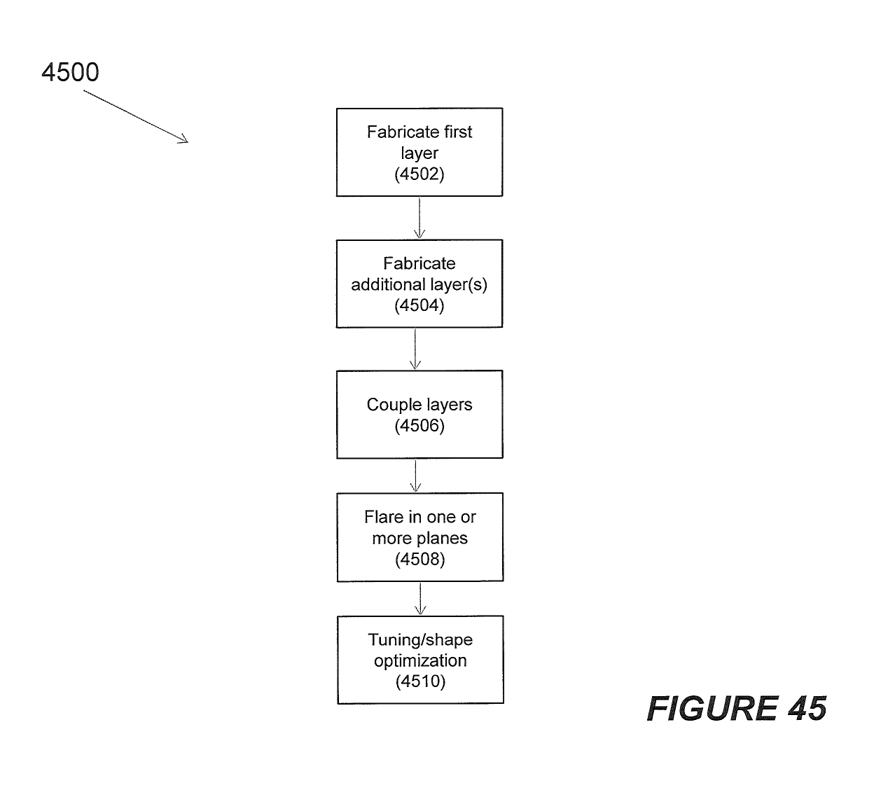

Referring now to FIG. 45, a flow chart of an exemplary method 4500 is shown. The method 4500 may be used to fabricate one or more of the structures described herein, such as a SIW antenna structure that is flared.

In block 4502, a first layer of a substrate may be fabricated. The first layer may be implemented by a microstrip line feeding structure and may be used for purposes of (routing) a signal, such as a 60 GHz signal.

In block 4504, one or more additional layers of the substrate may be fabricated. The additional layer(s) may be substantially thicker than the first layer and may have different properties from one another and/or the first layer.

In block 4506, the layers of blocks 4502 and 4504 may be coupled together, potentially via one or more ground layers.

In block 4508, the antenna structure may be flared in one or more planes. For example, the antenna structure may be flared in the E-plane or in both E and H planes.

In block 4510, matching posts may be incorporated. The positions of the posts, potentially in one or more dimensions (e.g., three dimensions) can be tuned to obtain a particular antenna performance (e.g., optimum performance). As part of block 4510, the shape of the SIW horn antenna can also be adjusted or optimized to reduce or eliminate reflections.

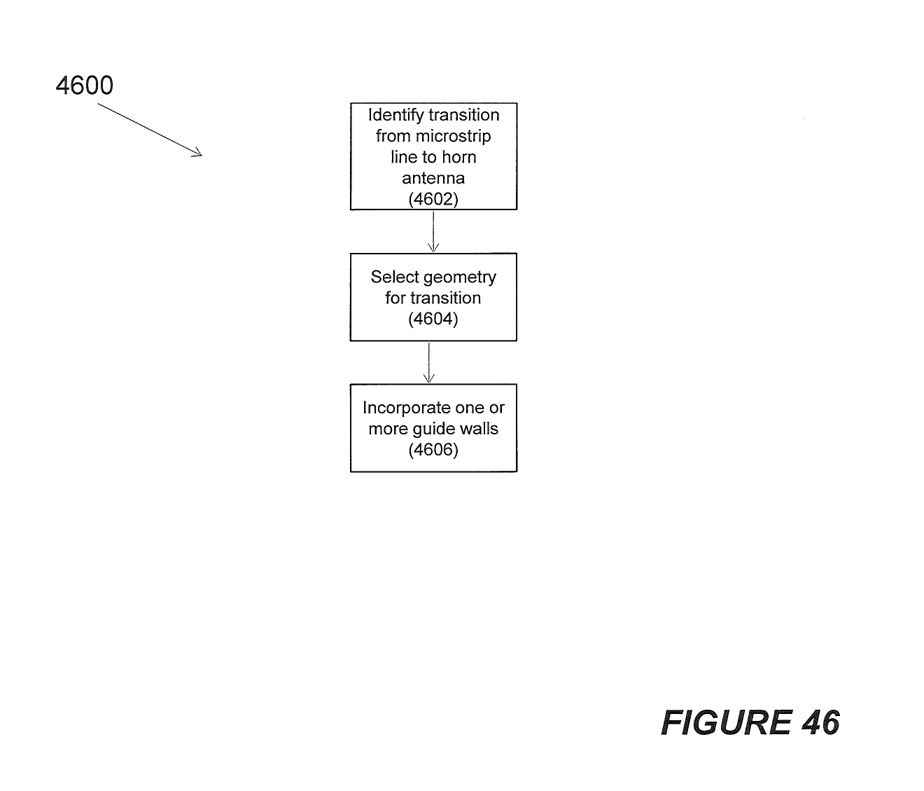

Referring now to FIG. 46, a flow chart of an exemplary method 4600 is shown. The method 4600 may be used to obtain a compact tunable broadband microstrip transition by use of a SIW.

In block 4602, a transition from a microstrip line to a horn antenna may be identified. As part of block 4602, one or more dimensions for the transition, the microstrip line, and/or the horn antenna may also be identified or determined.

In block 4604, a geometry for the transition may be selected. For example, a straight or linear transition may be selected. Alternatively, a curved transition may be selected (and a radius or degree of curvature may also be selected).

In block 4606, one or more guide walls may be incorporated. The angle, position, and number of the guide walls may be selected to obtain a particular bandwidth or to eliminate unwanted modes in the horn antenna.

As described herein, in some embodiments various functions or acts may take place at a given location and/or in connection with the operation of one or more apparatuses, systems, or devices. For example, in some embodiments, a portion of a given function or act may be performed at a first device or location, and the remainder of the function or act may be performed at one or more additional devices or locations.

Embodiments of the disclosure may be implemented using one or more technologies. In some embodiments, an apparatus or system may include one or more processors, and memory storing instructions that, when executed by the one or more processors, cause the apparatus or system to perform one or more methodological acts, such as those described herein. Various mechanical components known to those of skill in the art may be used in some embodiments.

Embodiments of the disclosure may be implemented as one or more apparatuses, systems, and/or methods. In some embodiments, instructions may be stored on one or more computer program products or computer-readable media, such as a transitory and/or non-transitory computer-readable medium. The instructions, when executed, may cause an entity (e.g., an apparatus or system) to perform one or more methodological acts, such as those described herein. In some embodiments, the functionality described herein may be implemented in hardware, software, firmware, or any combination thereof.

The particular embodiments disclosed above are illustrative only and should not be taken as limitations upon the present disclosure, as the disclosure may be modified and practiced in different but equivalent manners apparent to those skilled in the art having the benefit of the teachings herein. Accordingly, the foregoing description is not intended to limit the disclosure to the particular form set forth, but on the contrary, is intended to cover such alternatives, modifications and equivalents as may be included within the spirit and scope of the disclosure as defined by the appended claims so that those skilled in the art should understand that they can make various changes, substitutions and alterations without departing from the spirit and scope of the disclosure in its broadest form.

What is claimed is:

1. A substrate integrated waveguide (SIW) antenna structure comprising:
a first layer configured to route a signal;
at least a second layer configured for antenna use coupled to the first layer; and
a SIW antenna flared in the E-plane.

2. The SIW antenna structure of claim 1, wherein the signal comprises a 60 GHz signal.

3. The SIW antenna structure of claim 1, wherein the SIW antenna occupies a plurality of layers and extends in a direction perpendicular to a plane of a circuit substrate in a stair-cased fashion.

4. The SIW antenna structure of claim 1, wherein the first layer is implemented as a microstrip line feeding structure, and wherein the first layer is substantially thinner than the at least a second layer.

5. The SIW antenna structure of claim 4, wherein the microstrip line feeding structure is configured to directly feed the SIW antenna.

6. The SIW antenna structure of claim 1, further comprising:
a plurality of matching posts;
wherein a position of the matching posts is tunable in three dimensions to provide a specified bandwidth and radiation pattern.

7. The SIW antenna structure of claim 1, wherein the SIW antenna is flared in the H-plane.

8. A method comprising:
fabricating a first layer configured to route a signal;
fabricating at least a second layer configured for antenna use;
coupling the first layer and the at least a second layer; and
flaring a substrate integrated waveguide (SIW) antenna in the E-plane.

9. The method of claim 8, wherein the signal comprises a 60 GHz signal.

10. The method of claim 8, wherein the SIW antenna occupies a plurality of layers and extends in a direction perpendicular to a plane of a circuit substrate in a stair-cased fashion.

11. The method of claim 8, further comprising:
implementing the first layer as a microstrip line feeding structure;
wherein the first layer is substantially thinner than the at least a second layer.

12. The method of claim 11, wherein the microstrip line feeding structure is configured to directly feed the SIW antenna.

13. The method of claim 8, further comprising:
positioning a plurality of matching posts to provide a specified bandwidth and radiation pattern.

14. The method of claim 8, further comprising:
flaring the SIW antenna in the H-plane.

15. The method of claim 8, further comprising:
tuning a shape of the SIW antenna to minimize signal reflections.

16. A transition structure comprising:
a microstrip line;
an antenna; and
a transition configured to connect the microstrip line to the antenna, wherein the transition comprises a taper that narrows from the antenna to the microstrip line.

17. The transition structure of claim 16, wherein the transition is configured as a linear taper.

18. The transition structure of claim 16, wherein the transition is configured as a curved taper.

19. The transition structure of claim 16, further comprising a plurality of guide walls configured to guide a wave in the transition.

20. The transition structure of claim 16, wherein the antenna is configured to operate at 60 GHz.

21. The transition structure of claim 16, wherein the antenna is at least one of a substrate integrated waveguide (SIW) antenna and a horn antenna.

22. A structure comprising:
a microstrip transition;
a horn antenna coupled to the microstrip transition; and
a plurality of guide walls configured to guide a wave in a transition between the microstrip transition and the horn antenna.

23. The structure of claim 22, wherein the microstrip transition is coupled to a microstrip line, and wherein the microstrip transition comprises a curved taper.

24. A method comprising:
identifying a transition from a microstrip line to a substrate integrated waveguide (SIW) horn antenna structure configured to operate at 60 GHz; and
selecting a geometry for the transition.

25. The method of claim 24, further comprising:
incorporating a plurality of guide walls into the transition to guide a wave in the transition.

26. The method of claim 25, further comprising:
tuning the angle, position, and the number of guide walls to obtain a specified bandwidth.
